(19) United States
(12) Patent Application Publication
(10) Pub. No.: US 2002/0019447 A1
(43) Pub. Date: Feb. 14, 2002

(54) Physical forms of clarified hydrocolloids of undiminished properties and method of producing same

(76) Inventors: Donald Walter Renn, Glen Cove, ME (US); Nancy Amelia Blake, Point Roberts, WA (US)

Correspondence Address: SHLESINGER, ARKWRIGHT & GARVEY, LLP, 3000 South Eads Street, Arlington, VA, 22202, US

(21) Appl. No.: 09/804,402

(22) Filed: Mar. 13, 2001

Related U.S. Application Data
(63) Continuation-in-part of application No. 09/609,870, filed on Jul. 3, 2000.

(51) Int. Cl. B01F 3/12

(52) U.S. Cl. 516/77

(57) ABSTRACT

This invention relates to novel forms of clarified hydrocolloids including gels, films, foams, capsules and sponges. The invention also pertains to novel processes for producing the various physical forms of the clarified hydrocolloids. The invention also includes clarified hydrocolloid composites; borated cis 1,2-diol containing hydrocolloids; and clarified hydrocolloids of low viscosity.

This application is a continuation-in-part of application Ser. No. 09/609,870, filed Jul. 3, 2000.

### FIELD OF THE INVENTION

This invention relates to novel physical forms of clarified hydrocolloids, including in particular, gels, films, foams, capsules and sponges. The invention also pertains to novel processes for making the various physical forms of the clarified hydrocolloids.

### BACKGROUND OF INVENTION

Hydrocolloids made from naturally occurring gums are used extensively in the food, pharmaceutical and cosmetics industries. Examples of naturally occurring gums used in making hydrocolloid sols are konjac, guar, locust bean and xanthan. Sols of most such hydrocolloids are opaque or translucent. When such hydrocolloids are clarified, the cost is usually uneconomical or there is inevitably a loss in the physical properties of the hydrocolloids compared to the unclarified colloids. This can, for example, include substantial loss in viscosity.

Konijac glucomannan:

Konjac glucomannan, the first word sometimes spelled “konjak”, is an acetylated glucomannan obtained from the tubers of the tropical plant, Amorphophallus konjac, commonly called “Devil's Tongue” because of its high content of oxalic acid. The konjac tuber is harvested following two or three year's growth, after which it has a diameter of 4-6″. Processing steps include slicing, placing the slices on racks, sun or open fire drying, pulverization, dry or wet milling to remove the oxalic acid and some of the starch content which adheres to the konjac sacs, followed by sifting or air classification These oval sacs are about 2 mm long and are composed mostly of konjac glucomannan encased in a proteinaceous membrane. Starch granules adhere to the membrane and much of these can be removed by a 30% alcohol (aq) wash. Native konjac glucomannan has a wide variation of acetyl content since it is both a storage and a structural polysaccharide. The more acetylated forms of the konjac glucomannan are water-soluble and the more deacetylated forms are water-insoluble. This is a simplistic statement, however, since a whole spectrum exists with respect to degree of acetylation with some of the soluble species on the edge of insolubility and minor changes in environment, such as salt concentration, excessive heating, removal of protective hydrocolloids or other molecules, etc., can lead to insolubilization.

Crude konjac flour, the most common commercial form, is a well-known foodstuff in China and Japan and has recently gained FDA approval in the U.S. as a fat replacer in meat. This application is based on the fact that when konjac glucomannan is heated with alkali, about pH=7.5-11, deacetylation occurs and the resulting gel product is water insoluble and thermostable. The deacetylated gel or paste, commonly called “konnyaku” can even be fried at temperatures around 400° F. without melting or decomposing. If the gel formed by deacetylation is frozen and thawed, a tough, coherent spongeous mass is formed. Deacetylated konjac-containing films, foams, beads, and other forms can be prepared.

Konjac reacts with borate ion at alkaline pH to form amorphous gels as well as reacting synergistically with xanthan to form elastic gels.

As expected, there are numerous impurities in the crude, unclarified konjac. These include insoluble starches, cellulose, and nitrogen-containing impurities including proteins, many of which are derived from the konjac sac membrane. While crude konjac flours have numerous applications, as foods, as a soluble fiber source, as a fat replacement in meats, etc., the clarified form is preferable and in some applications, essential, for such applications as clear dessert gels, as a viscosifier or thickening agent for clear fluids, as clear capsules, films that are free from particulates, clear cosmetics, lotions and possibly gels in combination with clarified xanthan or borate, and the like.

Guar Gum (Galactomannan):

Guar gum is a galactomannan polysaccharide obtained from the seed of the legume Cyanopsis tetragonolobus, an annual plant that grows mainly in arid and semiarid regions of India and Pakistan. Guar is grown principally as a food crop for animals and as an ingredient in human foods and pharmaceuticals. The guar galactomannan is the major component in the seed endosperm, while the germ portion is mainly protein. In its commercial form, guar gum contains a significant number of impurities, including husks and other cellular debris, with the guar galactomannan comprising only about one-third of the product.

The guar galactomannan is composed of a backbone of (1-4)-linked β-D-mannopyranosyl units with single α-D-galactopyranosyl units connected by (1-6) linkages, with the ratio of galactose to mannose being about 0.55. There are many galactomannans in nature, each varying in this ratio which determines physical and chemical characteristics. Guar galactomannan is soluble in water to form viscous solutions. The actual viscosity values depend upon both the molecular weight and the purity. Guar gum imparts viscosity even in high ionic strength environments. Like konjac and locust bean gum, guar reacts synergistically with xanthan to form very viscous sols and/or gels, depending on proportions and concentrations. It also reacts with alkaline borate to yield amorphous gels.

Guar has numerous applications, some of which have been supplanted by guar derivatives. These range from oil drilling products to textile printing and dyeing to foods, cosmetics and pharmaceuticals.

Locust Bean Gum (Galactomannan):

Locust bean, carob, gum is a galactomannan polysaccharide obtained from the evergreen leguminous tree, Ceretonia siliqua L., which grows extensively in Spain is also cultivated in Italy, Cyprus and other Mediterranean countries. Locust bean gum is the refined endosperm of the seed and in its commercial forms locust bean gum contains a significant number of impurities, such as husk residue and cellular debris, depending on the grade.

Locust bean gum, like guar is a galactomannan having the same basic structure. However, there are considerably fewer galactose side-chains in the locust bean galactomannan. The galactose to mannose ratio is 0.25, compared with guar's 0.55. This lower degree of branching is responsible for differences in properties, especially solubility. While guar is mostly soluble in cold water, locust bean gum is not. Dispersions must be heated to about 85° C. to achieve full viscosity. Weak gels are formed when hot sols of locust bean gum are allowed to cool quiescently. Locust bean gum will gel in the presence of borate ion at alkaline pH. It will react synergistically with xanthan to form a gel and will impart elasticity to agar and κ-carrageenan gels. Locust bean gum is stable over a wide range of pH values, but is rapidly degraded by enzymes found in indigenous microbes.

While guar and guar derivatives have replaced locust bean gum in a number of applications because of cost-effectiveness considerations, locust bean gum is still used in dairy and frozen dessert applications, meat products, pet foods, and the textile industry.

Aloe Acemannan:

Aloe acemannan is a mannan first isolated from Aloe barbadensis (var. Miller) by McAnally at Carrington Laboratories and is pharmacologically active. In its commercial state, it contains fine water-insoluble particulates that impart turbidity to the sol. About 80% of the commercial product is a polysaccharide that is composed of a mannose backbone of from 5-50,000 linked units, with >75% being greater than 10,000. Commercial acemannan is partially water soluble and forms viscous sols. It, too, reacts synergistically with xanthan to form elastic gels and alkaline borate to form amorphous gels.

Xanthan Gum:

Xanthan gum is a so-called heteropolysaccharide obtained from the fermentation of Xanthamonas campestris. The polymer backbone is composed of (1→4)-linked β-D-glucopyranosyl units, the same as cellulose. Trisaccharide side chains are attached to alternate D-glucosyl units. These are composed of acetyl mannose, glucuronic acid, and mannose residues, with about half of the terminal mannose units containing pyruvate as a 4,6 cyclic acetal. Many commercial xanthan gum products form somewhat turbid sols, although most of the cellular debris is removed by centrifugation as a processing step. A few higher-value commercial products form an essentially clear sol as a result of an additional filtration step in the processing.

Xanthan gum imparts high viscosity to aqueous solutions at low concentrations. It is compatible with a wide pH range (1-13), being quite stable at ambient temperature for all values. Xanthan gum sols will also add viscosity to solutions having high salt content. Xanthan interacts synergistically with galactomannans, such as guar gum and locust bean gum, and konjac glucomannan to significantly increase viscosity and/or form gels. With these unique properties and its GRAS listing as a food additive, xanthan gum has a wide range of applications, from oil well drilling fluids to salad dressings, cosmetics, and pharmaceuticals.

Hydrocolloid Composites:

Hydrocolloid composites with varying components in various weight/weight ratios can be prepared by combining their sols and then recovering the product by one of any number of available methods. Although co-processed hydrocolloids and dry physical mixtures of hydrocolloid powders exhibit essentially the same solution properties, their dispersion and water absorption properties can be significantly different and vary according to the relative proportions.

Hydrocolloid/Borate Interaction Products:

At pH values between about 7.5 and 9.0, the borate ion will interact with polymers containing cis-1,2-diols to form more viscous, amorphous systems. These polymeric diols can be synthetic, semi-synthetic, or natural. Some of the more common polymers which undergo this reaction are the polyvinyl alcohols; galactomannans, such as guar gum and locust bean gum; and glucomannans, such as konjac and Aloe (ace) mannans. Depending on the concentration of the polymer, or polymers if two or more are used, the borate concentration, and other additives, if any, the consistency can vary from somewhat viscous fluids to crisp amorphous solids. At selected concentrations of the individual components, the reaction products behave like “healable” solids that will flow at body temperatures. Other soluble and insoluble materials can be added to impart desired properties, such as increased fluid absorption, fluid donation, elasticity, etc.

### RELEVANT PRIOR ART

Konjac Clarification:

Snow, W. C. and Renn, D. W. Clarified and cold-melt konjac glucomannan. Patent Nos. WO 09302571 (2118/93) and EP 646133A1 (Apr. 5, 1995).

(Use of considerable heating, a variety of salts and other reagents, along with filter aid to clarify konjac and reduce turbidity (20-100 NTUs), nitrogen and UV spectral absorbance.)

Ohashi, S., Shelso, G. J., Moirano, A. L., and Drinkwater, W. L. Clarified konjac glucomannan. Patent Nos. WO 09303047 (Feb. 18, 1993) and EP 00646134A1 (Apr. 5, 1995).

(Use of considerable heat to dissolve and filter. Impurities precipitated using aluminum sulfate or other salts such as calcium and magnesium sulfate, filtering, then recovering using isopropyl alcohol. Reconstituted konjac has an aqueous sol turbidity potential of less than 20 turbidity units . . . )

Asahi Kasei Kogyo KK. Glucomannan eye drops. Japan Patent JP6345653 (Dec. 20, 1994).

(Konjac powder, PROPOL PA, was stirred in distilled water for dissolution then centrifuged at 2000 rpm for 10 minutes after which the supernatant had a “first grade white turbidity”. This was diluted with distilled water and heated to boiling.)

Maekaji, K. The Mechanism of Gelation of Konjac Mannan. Agr.Biol.Chem. 38 (2), 315-321 (1974).

(Insolubles were removed by filtration of a 0.5% sol after stirring the dispersion for two hours at room temperature, by filtration through a glass filter.)

Jacon, S. A., Rao, M. A., Cooley, H. J., and Walter, R. H. The isolation and characterization of a water extract of konjac flour gum. Carbohydrate Polymers 20, 3541 (1993).

(A 0.6% sol of konjac flour in distilled water was agitated for 1.5 hours in a temperature regulated shaker held at approximately 70° C. Insolubles were removed by centrifugation and the supernatants coagulated in 3 volumes of 99% ethanol. Precipitate separated, washed with ethanol, then dried to constant weight at 105° C.)

Morita, S., Morita, H., Shibata, K., and Nakayama, H. Gel for zone electrophoresis. Jpn. Kokai Tokkyo JP 04,248,460 [92,248,460].

(Clarification of a 0.4% sol by centrifugation, determination of dry weight and using clarified konjac sol directly without drying.)

Nippon Chemifar Co., Ltd. Konjac glucomannan manufacture. Jpn. Kokai Tokkyo Koho JP 58,213,001 [83,213,001] (Dec. 10, 1983).

(Dissolving overnight at room temperature, centrifuging, coagulating supernatant in ethanol, redissolving, centrifuging, coagulating, and freeze-drying.)

Ogasawara, S. Yamazaki., and Nunomura, W. Electrophoresis on konjac mannan gel. Seibutsu Butsuri Kagaku 31(3)155-8(1987).

(50% ethanol for a week, centrifuged, pellets in 80% ethanol for 3 days, centrifuged, washed, filtered. Never dissolved.)

Sugiyama, N. and Shimahara, H. Method of reducing serum cholesterol level with extract of konjac mannan. U.S. Pat. No. 3,856,945 (Dec. 24, 1974).

(Konjac purified by dissolving the konjac flour in water, filtering through 150 mesh nylon then a glass filter, dialyzing and freeze-drying. Product is cloudy when reconstituted. Not a commercially viable process.)

Sugiyama, N. and Shimahara, H. Konjac mannan. U.S. Pat. No. 3,926,322 (Dec. 23, 1975).

(Dissolving in water, removing insolubles by filtration or centrifugation, freeze drying.)

Sugiyama, N. and Shimahara, H. Konjac mannan. U.S. Pat. No. 3,973,008 (Aug. 3, 1976).

(Dissolving in water, removing insolubles by filtration or centrifugation, dialyzing and freeze drying.)

Izumi, T. et al. Use of glucomannan for the separation of DNA fragments by capillary electrophoresis. Journal of Chromatography A, 652, 41-46 (1993).

(Use of non-deacetylated konjac as medium for capillary electrophoresis.)

Ogasawara, S. et al. Electrophoresis on Konjac mannan gel. Seibutsu Butsuri Kagaku 31, 155-158 (1987).

(Use of konjac gels for electrophoretic separations in non-denaturing buffer systems.)

Morita, S. et al. Gel media for zone electrophoresis of proteins or nucleic acids. Jpn. Kokai Tokkyo Koho JP 04,248,460 (913192) CA117: 248159 g (1992).

(Gel matrix of agarose and konjac glucomannan used for nucleic acid and protein separations in non-denaturing buffers.)

Clarified Partially Depolymerized Konjac:

Tomita, M., Ono, J., Fukuwatari, Y., Mizota, T., and Nanba, K. Water-soluble dietary fibers and method for preparation of same. U.S. Pat. No. 4,971,814 (Nov. 20, 1990).

(Konjac powder is partially hydrolyzed using cellulase from Aspergillus to yield dietary fibers with average M.W. of 2,000-15,000.)

Tomita, M., Shimamura, S., Fukuwatari, Y. and Nanba, K. Glucomannan hydrolysates for treatment of intestinal cancer. Japan Kokai Tokkyo Koho JP 05,246860 (Sep. 24, 1993). (Chem. Abstr, 120, 14904, 1994).

(Konjac glucomannan was partially hydrolyzed using cellulase and products used as anticholesteremics and antitumor agents in the large intestine.)

Takahashi, R., Ksusakabe, I., Kusama, S., Sakurai, Y., Murakami, K., Maekawa, A., and Suzuid, T. Structures of Glucomanno-oligsaccharides from the Hydrolytic Products of Konjac Glucomannan Produced by a β-Mannanase from Streptomyces sp. Agric. Biol. Chem, 48 (12) 2943-2950 (1984).

(Konjac glucomannan hydrolyzed with a purified mannanase.)

Tiefenthaler, K. H. O. and Wyss, U. Water soluble guar product and method for making it. U.S. Pat. No. 4,320,226 (Mar. 16, 1982).

(Depolymerization of guar gum in the presence of alkali.)

Guar Gum Clarification:

Naoki, M., Shiyoujo, S., and Taku, T. Purification of galactomannan. Japan Patent JP63101402A (Sep. 17, 1984).

(Galactomannan is contacted with an alkali metal hydroxide (e.g., sodium hydroxide) in a medium comprising water or a mixture of water with a hydrophilic organic solvent. The product is then neutralized with neutralizing agent (e.g., hydrochloric or sulfuric acid) to obtain the desired galactomannan.)

Mitsuo, M. Purification of Galactomannan. Japan Patent JP5239105 (Sep. 17, 1993).

(An aqueous solution of crude galactomannan is blended with a chelating agent, the blended solution is filtered, the filtrate is mixed with a precipitating agent for galactomannan to recover and purify galactomannan.)

Mitsuo, M. Purification of Galactomannan. Japan Patent JP5239106 (Sep. 17, 1993).

(An aqueous solution of crude galactomannan is blended with a monosaccharide, the blended solution is filtered, the filtrate is mixed with a precipitating agent for galactomannan to recover and purify galactomannan.)

Hirofumi, N., Hideki, Y., and Michiyoshi, A. Purification of galactomannan. Japan Patent JP63035606 (Feb. 16, 1988).

(The pH of an aqueous solution obtained by dissolving a galactomannan-containing product such as crushed guar beans, locust beans or tara beans in hot water at 70° C. or above is adjusted to 4.5-6.5 by adding an acid to the solution. A filter aid (e.g., Perlite) of a mean particle diameter of 15-20 microns is added to this aqueous solution. This solution is filtered to remove insoluble matter such as protein and cellulose, and a hydrophilic organic solvent such as methanol or isopropyl alcohol is added to the filtrate to precipitate the gum. This gum is dehydrated by pressing, dried and ground.)

Noble, O., Turquois, T, and Taravel, F. R. Rheological Properties of Galactomannan-Based Gels. Part I—Guar and Hydroxypropylguar Gels in Alkaline Media. Carbohydrate Polymers 12, 203-217 (1990).

(Guar gum purified by dispersing in stirring water at 60° C. and stirring rapidly for 1 or 2 hours. Insoluble material was removed by centrifugation and supernatants precipitated by addition of 95% isopropyl alcohol. Precipitate washed with ethanol and vacuum dried.)

Locust Bean Gum Clarification:

Braun et al. Preparation of Vegetable Gum Solutions. U.S. Pat. No. 2,144,522 (Jan. 17, 1939).

(Decolorizing and clarifying locust bean gum by adding activated carbon and aluminum sulfate, filtering, and coagulating in isopropyl alcohol.)

Foster, S. Treatment of Manno Galactan Gums. U.S. Pat. No. 3,346,556. (Oct. 10, 1967)

(Example 5 discloses a means for clarifying locust bean gum by adding diatomaceous earth and filtering.)

Naoki, M., Shiyoujo, S., and Taku, T. Purification of galactomannan. Japan Patent JP63101402A (Sep. 17, 1984).

(Galactomannan is contacted with an alkali metal hydroxide (e.g., sodium hydroxide) in a medium comprising water or a mixture of water with a hydrophilic organic solvent The product is then neutralized with neutralizing agent (e.g., hydrochloric or sulfuric acid) to obtain the desired galactomannan.)

Mitsuo, M. Purification of Galactomannan. Japan Patent JP5239105 (Sep. 17, 1993).

(An aqueous solution of crude galactomannan is blended with a chelating agent, the blended solution is filtered, the filtrate is mixed with a precipitating agent for galactomannan to recover and purify galactomannan.)

Mitsuo, M. Purification of Galactomannan. Japan Patent JP5239106 (Sep. 17, 1993).

(An aqueous solution of crude galactomannan is blended with a monosaccharide, the blended solution is filtered, the filtrate is mixed with a precipitating agent for galactomannan to recover and purify galactomannan.)

Hirofumi, N., Hideki, Y., and Michiyoshi, A. Purification of galactomannan. Japan Patent JP63035606 (Feb. 16, 1988).

(The pH of an aqueous solution obtained by dissolving a galactomannan-containing product such as crushed guar beans, locust beans or tara beans in hot water at 70° C. or above is adjusted to 4.5-6.5 by adding an acid to the solution. A filter aid (e.g., Perlite) of a mean particle diameter of 15-20 microns is added to this aqueous solution. This solution is filtered to remove insoluble matter such as protein and cellulose, and a hydrophilic organic solvent such as methanol or isopropyl alcohol is added to the filtrate to precipitate the gum. This gum is dehydrated by pressing, dried and ground.)

Morikawa, M. and Suzuki, S. Purification of locust bean gum. JP63105004 (May 10, 1988).

(Crude locust bean gum is dissolved in warm water and filtering, followed by recovering the locust bean gum and drying.)

Xanthan Gum Clarification:

Kang, K. S. and Petitt, D. J. “Xanthan, Gellan, Welan, and Rhamsan” in Industrial Gums, Polysaccharides and Their Derivatives. Third Edition. Whistler, R. L. and BeMiller, J. N., Editors. Academic Press, 1992, page 346.

(“A clear product can be produced by diluting the fermentation liquor and clarifying it by filtration.”)

Rinaudo, M., Milas, M., and Kohler, N. Enzymatic clarification process for improving the injectivity and filtrability of xanthan gums.

(Abstract: Enzymatic treatment, in aqueous dispersion, of a xanthan gum containing bacteria cell residues and microgels, as impurities, by means of a Basidomycete cellulase . . . , improved the infectivity and filtrability thereof.)

Murofushi, K., Nagura, S., Homma, T., and Armentrout, R. Process for preparation of a purified xanthan gum. European Patent Application No. 92311401.1 (Jun. 30, 1993).

(Heat treatment followed by alkaline protease and lysozyme, then recovering the xanthan from the broth. “A clear aqueous solution of the xanthan gum may be obtained without complex procedures”.)

Aloe Acemannan Clarification:

McAnnalley, B. H. Process for preparation of aloe products, products produced thereby and compositions thereof. U.S. Pat. No. 4,735,935 (Apr. 5, 1998).

(Patent covering isolation of acemannan.)

McAnnalley, B. H. Process for preparation of aloe products, products produced thereby and compositions thereof. U.S. Pat. No. 4,917,890 (Apr. 5, 1988).

(Patent covering isolation of acemannan.)

Vilkas, E. and Radjabi-Nassab, F. The glucomannan system from Aloe vahombe (liliaceae), III. Comparative studies on the glucomannan components isolated from the leaves. Biochemie 6, 1123-1127 (1986).

(Aqueous sol prepared and centrifuged. Supernatant coagulated in ethanol.)

Mandal, G. and Das, A. Structure of the glucomannan isolated from the leaves of Aloe barbadensis (MILLER) Carbohydrate Research 87, 249-256 (1980).

(Aqueous sol prepared and centrifuged.)

Hydrocolloid Co-processing:

Yoshida, H., Kamiya, S., Takano, Y., and Toba, S. Instant konjac mannan food. Jpn. Kokai Tokkyo Koho JP62 96,061 (May 2, 1987).(Chem. Abstracts 107, 133074 (1987).

(“A solution containing konjac mannan and xanthan gum (95-5:5-95) at acidic to neutral pH is dried to give an instant konjac mannan food with high water absorbency and reconstitution rate”. Konjac was not deacetylated.)

Kira, M. Preparation of agar gel (tokoroten) containing glucomannan. JPN. Kokai Tokkyo Koho JP 05, 199,853 (Aug. 10, 1993). (CA 119:224827 1993).

(“Tokoroten with improved strength and elasticity and yet without the odor of agar is prepared by the addition of glucomannan and thickening agents into the weak alkali-treated agar. After the mixture is heated to dissolve, it can be deodorized and decolorized prior to gelling”.)

Tako, M. Synergistic Interaction between Xanthan and Konjac Glucomannan in Aqueous Media. Biosci. Biotech. Biochem. 56(8), 1188-1192 (1992).

(Synergistic gel formation described for native, de-pyruvated, and de-acetylated clarified xanthan and clarified konjac. For clarification of the xanthan, a 0.1% sol of commercial xanthan in distilled water was heated at 90° C. for 30 minutes, then cooled to room temperature and filtered through Celite 545. The filtrate was made to 0.1% with KCl, coagulated in 2 volumes of ethanol, the precipitate collected and dried in vacuo. The konjac flour was soaked in 50% ethanol for three days at room temperature. The suspension was filtered and the residue was dissolved by stirring with distilled water at 90° C. for 30 minutes. The sol was filtered through Celite 545 and the clear filtrate coagulated in 2 volumes of ethanol. The precipitate was collected and dried in vacuo.)

Nippon Chemipharm. Manufacture of konnyaku glucomannan for electric migration gel materials. Jpn. Kokai Tokkyo Koho JP58, 213,001 (Dec. 10, 1983).

(Purification by forming a sol, centrifuging, and coagulating the supernatants in ethanol.)

Kawano, N. Instantly Soluble Glucomannan Composition, Its Use and Preparation. Japan Patent Disclosure No. H5-38263. (Feb. 19, 1993).

(Fluidized bed granulation and drying of mixed polysaccharides, including konjac.)

Fujihara, K. and Nakagawa, T. Method of producing readily soluble polysaccharides. Japan Patent Disclosure No: 1982-[Showa]-28.203 (Feb. 15, 1982).

(Dissolving polysaccharides or mixtures and spray-drying. Only mixture given is locust bean gum/xanthan.)

Musson, G. D. and Prest, C. T. Thermo-irreversible edible gels of glucomannan and xanthan gums. U.S. Pat. No. 4,894,250 (Jan. 16, 1990).

(Preparation of deacetylated konjac gels containing xanthan and, optionally, carrageenan, pectin, algin, agar, gellan, and/or guar.)

Fukuda, T. Manufacture of dried konjac with mono- and/or oligosaccharides. Japan Kokai Tokkyo Koho JP 04 08,257 (Jan. 13, 1992) CA 116:172746c (1992).

(Dry konjac is manufactured by mixing konjac with mono- and/or oligosaccharides and drying. Rehydration in water restores its original gel state.)

Kawano, K. Instantly soluble glucomannan composition, its use and preparation Japanese Unexamined Patent Application Disclosure H5-38263 (Feb. 19, 1993) WPI Acc No: 93-096400/12.

(Non-deacetylated konjac is co-processed with a variety of hydrocolloids (carrageenan, xanthan, agar, alginates, pectin, starch CMC, polyacrylates, etc.) by mixing in the fluid state, then drying to give products that are readily dispersible and soluble in water.)

Renn, D. W., Lauterbaugh, G. E., and Hemmingsen, P. Soluble dried cassia alloy gum composition and process for making same. U.S. Pat. No. 4,952,686 (Aug. 28, 1990).

(The initial patent on the technique of co-processing insoluble or poorly soluble hydrocolloids with one or more other hydrocolloids to impart solubility or other important properties. Clarified Cassia galactomannan coprecipitated with various gums to improve solubility of the galactomannan. Composite of clarified Cassia gum and xanthan is highly water absorbent.)

Snow. W. C. and Renn, D. W. Glucomannan spongeous matrices. Patent Nos. WO 09402029A1 (213194) and EP 650348A1 (May 3, 1995).

(Konjac co-processed with agar or at least one other gelling polysaccharide to form a spongeous matrix.)

Yoshida, H. et al. Instant Konjak mannan food. Jpn. Kokai Tokkyo Koho JP 62 96,061 (May 2, 1987) CA 107: 133085f (1987).

(Solution of konjac mannan and xanthan at acidic to neutral pH was dried to give an instant konjac mannan product with high water-absorbency and reconstitution rate. Konjac was not deacetylated.)

Applegren, C. H. Process for preparing a product comprising guar-gum. U.S. Pat. No. 4,754,027 (Jun. 28, 1988).

(Guar composites produced by granulating non-clarified guar with sols of non-gelling hydrocolloids.)

Toba, S., Yoshida, H., and Tokita, T. Konjac mannan-containing reversible gel. U.S. Pat. No. 4,676,976. (Jun. 30, 1987).

(Reversible konjac/xanthan gel formation with strongest gels at 4:1 ratio.)

Ishikawa, H. et al. Preparation of freeze-resistant konjac. Japanese Patent Application No. 604019, filed Jan. 16, 1985, abstract published Dec. 12, 1986.

(Co-processed, but not dried, deacetylated konjac and insoluble alginate.)

Ueno, K. Preparation of konjak resistant to freezing. Jpn. Kokai Tokkyo Koho JP 05 00,055 (Jan. 8, 1993) CA118: 146606d (1993).

(“Konjak resistant to freezing is prepared by adding starch and natural gums, e.g., locust bean gum and tara gum”.)

Umehara, S. et al. A dry gel containing starch and konnyaku mannan as an instant konnyaku. Jpn. Kokai Tokkyo Koho JP 62, 259,550 (Nov. 11, 1987) CA108: 149158p (1988)

(Dried gel of deacetylated konjac and starch that hydrates to gel particles in boiling water.)

Vernon, A. J. et al. Thermo-irreversible gelling system and edible materials based thereon. European Patent Application Publication No.: 0 050 006 (Jul. 10, 1981).

(Konjac and carrageenan gelled using phosphate buffer and heat.)

Suto, S. et al. Scanning electron microscopy of blend of konjac mannan and hydroxypropyl cellulose. Sen-I Gakkaishi 48(8) 437-440 (1992).

(Gel prepared from blend of konjac and hydroxypropyl cellulose.)

Ikeda, M. and Harada, S. Low calorie processed food made with gel particles of glucomannan coagulum. U.S. Pat. No. 5,213,834 (May 25, 1993).

(Encapsulated organic acids to neutralize alkaline gels of konjac and konjac gels made with the addition of other hydrocolloids, such as carrageenan, alginates, locust bean gum, agar, xanthan, etc.)

Kawano, N. Instantly soluble glucomannan composition, its use and preparation. Japanese Unexamined Patent Application Disclosure H5-38263 (Feb. 19, 1993) WPI Acc No: 93-096400/12.

(Non-deacetylated konjac is coprocessed with a variety of hydrocolloids (carrageenan, xanthan, agar, alginates, pectin, starch CMC, polyacrylates, etc.) by mixing in the fluid state, then drying to give products that are readily dispersible and soluble in water.)

Hydrocolloid Films, Foams, Gels, and Sponges:

Harper, D. A., Morgan, J. H., Nochumson, S., Ostrovsky, M. V., Renn, D. W., Snow, W. C. Agarose compositions for nucleic acid sequencing. U.S. Pat. No. 5,455,344 (Oct. 3, 1995).

(Sequencing nucleic acids using a polysaccharide gel medium in the presence of denaturing agents—includes deacetylated konjac gels.)

Snow, W. C. and Renn, D. W. Glucomannan spongeous matrices. Patent Nos. WO 09402029A1 (Feb. 3, 1994) and EP 650348A1 (May 3, 1995).

(Konjac co-processed with agar or at least one other gelling polysaccharide to form a spongeous matrix upon freezing and thawing.)

Masao, K. Glucomannan/polyhydric alcohol composition and film prepared therefrom. European Patent Application Publication No. 0 273 069 (Jun. 7, 1988).

(Konjac glucomannan films and applications.)

Kakizaki, T. and Kdubodera, M. Edible glucomannan film for food packing. Jpn. Kokai Tokkyo Koho JP 62,126,950 (Jun. 9, 1987). (CA107, 613, (1987).

(“A composition containing glucomannan, optionally other natural polysaccharides, and one or more of polyhydric alcohols, sugar alcohols, monosaccharides, disaccharides, and oligosaccharides is kneaded, dissolved in water, and made into a film to produce an edible film for food packaging”.)

Merritt II, F. M. Edible film and method. U.S. Pat. No. 5,962,053. (Oct. 5, 1999).

(Abstract: Described is an edible, water insoluble film which is a blend of polysaccharide and protein and, in particular, a ternary blend of konjac flour as a major constituent, agar and gelatin. Also described is a method of forming the film including a deacetylating step to insolubilze the konjac flour.)

Nussinovitch, A. Sponge comprising expansion product of hydrocolloid. WO 9417137 A (Aug. 4, 1994).

(“Sponge is formed by foaming one or more hydrocolloids selected from agar, carrageenan, gelatin, alginate, starch, pectin, gellan, konjak, mannan or xanthan, locust bean gum. The sponge containing a plasticiser (esp. glycerol, sorbitol or other polyol), a sugar or sugar substitute, bubbles of a gas other than air and opt. a flavoring agent or taste enhancer.”)

Tanabe, O. et al. Fiber-rich foods made from Konjak flour. Jpn. Kokai Tokkyo Koho JP 01, 256,366 (414188) CA113: 57776p (1990).

(Water-insoluble, gelled deacetylated konjac recovered by freeze thawing—not dried.)

Sakamoto, J. and Tanuma, H. Low-calorie food products containing konjac mannan and processes for preparing the same. U.S. Pat. No. 5,116,631.

(Non-deacetylated konjac as a foam stabilizer for egg white meringues.)

Ford, D. M. and Cheney, P. A. Air or oil emulsion food product having glucomannan as sole stabilizer-thickener. U.S. Pat. No. 4,582,714.

(Non-deacetylated konjac as a aerated food stabilizer.)

Nozaki, H. et al. Devil's tongue-containing whipped cream. Japanese Patent Application No. 01-177050, filed Jul. 11, 1989, abstract published May 7, 1991.

(Prepared alkaline deacetylated gel added to cream while whipping.)

Sawaguchi, K. Meringue. Japanese Patent Application No. 57-126718, filed Jul. 22, 1982, abstract published May 12, 1984.

(Use of non-deacetylated konjac to stabilize meringues.)

Sugino, Y. Porous gel foods and their manufacture from glucomannan and whipped egg white. Jpn. Kokai Tokkyo Koho JP 04 11,85 (Jan. 16, 1992).

(Egg white/konjac whipped together then set (deacetylated) with calcium hydroxide and heat.)

Bakis, G. et al. Production of polysaccharide foam comprises mechanically foaming aqueous solutions of soluble polysaccharide, e.g., alginate, hyaluronate, carrageenan, chitosan or starch. WO 9400512 (Jan. 6, 1994) WPI Acc No: 94-026166/03.

(Mechanically foaming an aqueous solution of a polysaccharide and used as wound dressing, etc.)

Borate Interaction Products:

Renn, D. W. Solid borate-diol interaction products for use in wounds. World Patent WO 09953968A1 (Oct. 28, 1999).

(Interaction of sodium tetraborate with PVA and polysaccharides, glucomanans and galactomannans, having a cis-1,2-diol configuration in their structure.)

Hogi, T. and Kameda, N. Transparent konnyaku mannan gels for optical products. JP 05,194,603 (93, 194,603). Aug. 3, 1993.

(Konjac mannan and sodium tetraborate product for contact lenses and medical optical devices.)

Muller, E. G. Borated polysaccharide absorbents and absorbent products. U.S. Pat. No. 4,624,868. Nov. 25, 1986.

(Guar gum as an exemplification of cis-1,2-diol polysaccharides is first hydrated then thickened by cross-linking with borax, and finally dried to a powder to flake form, preferably by freeze drying. The resulting particles can absorb up to 100 times their weight or more of aqueous fluids such as urine. Absorbent articles, such as disposable diapers, bandages, and the like are formed with the borax-cross-linked guar gum as absorbent.)

Anderson, R. L. Flushable premoistened wiper. U.S. Pat. No. 4, 362, 781. 07 December 1982.

(Premoistened wiper comprising a nonwoven web impregnated with a modified guar gum (phosphated) (5-14% of fiber weight) and wet with an aqueous lotion containing borate ions. Lotion also contains an organic hydroxy or keto acid or salt thereof (such as potassium citrate) capable of complexing with borate ions.)

Zimmerman, V. et al. Thin sanitary products with a pre-fabricated absorbent body. International Application Publication No. WO 95/17147. 29 June 1995.

(Fibers coated with particles of a galactomannan, or derivative thereof.)

Rademacher, K. and Fritsce, U. (Sebapharma) Dressing system. WO 9203172. 20 February 1992.

(The bandage, dressing or support matrix consists of a biocompatible, open-pored plastic foam with a hydrogel embedded in the pores. The hydrogel is formed from a borate-modified Guar gum . . . )

### SUMMARY OF INVENTION

The invention pertains to a process of producing a clarified konjac glucomannan gel or sponge, or clarified konjac glucomannan or clarified aloe mannan film, foam or capsule comprising: (a) soaking dispersed konjac glucomannan or aloe mannan in water until the konjac glucomannan or aloe mannan is hydrated; stirring the hydrated konjac glucomannan or aloe mannan until a homogenous particulate containing sol is obtained; removing insoluble particulates from the particulate containing sol to produce a clarified sol; and recovering clarified konjac glucomannan or aloe mannan from the filtrate; (b) when a clarified konjac glucomannan gel is required, adding an appropriate amount of a suitable alkaline agent to the clarified konjac glucomannan of step (a) to deacetylate the sol to form a gel; (c) when a flexible water soluble film is required, adding an appropriate amount of glycerol or other plasticizer to the clarified konjac glucomannan or aloe mannan of step (a), dissolving the konjac glucomannan or aloe mannan, glycerol or other plasticizer mixture, casting the mixture as a film, and drying the film; (d) when a flexible hot water soluble film is required, adding an appropriate amount of clarified xanthan and glycerol or other plasticizer to the clarified konjac glucomannan or aloe mannan of step (a) to form a mixture, dissolving the mixture, casting the mixture as a film, cooling the film to a gel and drying the gel to form a film; (e) when a flexible water-insoluble film is required, adding an appropriate amount of glycerol or other plasticizer and alkaline agent to the clarified konjac glucomannan of step (a) to form a mixture, dissolving the mixture, casting the mixture as a sol, heating the sol to deacetylate the mixture to form a gel and drying the gel to form a film; (f) when a rigid water soluble film is required, following step (c) but omitting the glycerol or other plasticizer; (g) when a rigid hot water soluble film is required, following step (d) but omitting the glycerol or other plasticizer; (h) when a rigid water insoluble film is required, following step (e) but omitting the glycerol or other plasticizer; (i) when a water-imbibing film that forms an amorphous gel is required, adding an appropriate amount of glycerol and borax to the clarified konjac glucomannan or aloe mannan of step (a), dissolving the mixture, casting the mixture as a film and drying the film; (j) when a stabilized foam is required, adding a foaming agent and a suitable amount of glycerol to the clarified konjac glucomannan of step (a) to form a mixture, aerating the mixture to produce a foam, adding a suitable amount of alkaline agent to the foam, heating the foam to set the foam and drying the foam; (k)when a flexible rubbery type foam is required, adding a suitable amount of foaming agent, clarified xanthan and glycerol or other plasticizer to the clarified konjac glucomannan or aloe mannan of step (a) to form a mixture, heating the mixture to form a sol, aerating the mixture to produce a foam, cooling the foam to set the foam, and drying the foam; (l) when a sponge cloth-like foam of clarified konjac mannan is required, following step (j), but before drying the foam, freezing and thawing the foam, squeezing the foam, rinsing the foam, soaking the foam in isopropyl alcohol and drying the foam; (m) when a flexible, dry foam which rehydrates to form an amorphous gel is required, adding a suitable amount of detergent and glycerine or other plasticizer to the clarified konjac glucomannan of step (a) to form a mixture, aerating the mixture to form a foam, adding a suitable amount of borate to the foam, aerating the foam further, cooling the foam and then drying the foam; (n) when a firm water absorbent sponge is required, adding an alkaline agent to a sol of the clarified konjac glucomannan of step (a) to form a mixture, heating the mixture until a gel is formed, freezing the gelled mixture, thawing the gelled mixture, and drying the gelled mixture; and (o) when a flexible water absorbent sponge is required, following step (n) but before drying and after thawing the sponge, soaking the sponge in isopropyl alcohol containing a plasticizer such as glycerin, squeezing the sponge and drying the sponge.

The invention is also directed to a process of producing a clarified guar gum or clarified locust bean gum, or other clarified galactomann gel, film, foam or capsules comprising: (a) soaking dispersed guar gum or locust bean gum in water until the guar gum or locust bean gum is hydrated, stirring the hydrated guar gum or heating the locust bean gum with stirring until a homogenous particulate containing sol is obtained, removing insoluble particulates from the particulate containing sol to produce a clarified sol, and recovering clarified guar gum or locust bean gum from the filtrate; (b) when a water soluble film is required, adding an appropriate amount of glycerol or other plasticizer to the clarified guar gum or locust bean gum of step (a), dissolving the guar gum or locust bean gum, glycerol or other plasticizer mixture by heating to form a sol, casting the sol as a film, and drying the film; (c) when a flexible hot water soluble film is required, adding an appropriate amount of clarified xanthan and glycerol or other plasticizer to the clarified guar gum or locust bean gum of step (a) to form a mixture, dissolving the mixture by heating to form a sol, casting the sol, cooling to form a gel and drying the gel to form a film; (d) when a rigid water soluble film is required, following step (b) but omitting the glycerol or plasticizer; (e) when a rigid hot water soluble film is required, following step (c) but omitting the glycerol or other plasticizer; (f) when a water-imbibing film that forms an amorphous gel is required, adding an appropriate amount of glycerol and borax to a sol of the clarified guar gum or locust bean gum of step (a), casting the sol as a film, allowing the sol to cool and drying the gel to form a film; and (g) when a stabilized foam is required, adding a suitable amount of glycerol and clarified xanthan to the clarified guar gum or locust bean gum of step (a) to form a mixture, heating the mixture, adding a foaming agent to the mixture, aerating the mixture to produce a foam, cooling the foam to set the foam and drying the foam.

The invention also pertains to a process of producing a clarified konjac glucomannan hydrocolloid gel comprising: (a) soaking a dispersed konjac glucomannan in water until the konjac glucomannan is hydrated; (b) stirring the hydrated konjac glucomannan until a homogenous particulate containing sol is obtained; (c) removing insoluble particulates from the particulate containing sol to produce a clarified sol; (d) removing remaining particles in the clarified konjac glucomannan sol by filtration; (e) recovering clarified konjac glucomannan from the filtrate; and (f) adding an appropriate amount of a suitable alkaline agent to the clarified konjac glucomannan to deacetylate the sol to form a gel. The filtrate of step (e) can be dried and ground into a powder and reconstituted with water before proceeding to step (f).

The invention is also directed to a process of producing a water soluble flexible clarified hydrocolloid film comprising: (a) soaking a dispersed hydrocolloid containing material in water until the hydrocolloid is hydrated; (b) stirring the hydrated hydrocolloid until a homogenous particulate containing sol is obtained; (c) removing insoluble particulates from the particulate containing sol to produce a clarified sol; (d) removing remaining particulates in the clarified sol by filtration and recovering clarified hydrocolloid from the filtrate; (e) adding an appropriate amount of glycerol or other humectant/plasticizer to the clarified hydrocolloid to form a mixture; (f) heating the mixture to boiling; and (g) depositing the mixture as a layer on a substrate and drying the layer to form a film.

The hydrocolloid can be selected from one or more of the group consisting of: konjac glucomannan, guar gum, locust bean gum, aloe mannan, agar, agarose, algins, β-, κ-, λ-ι-carrageenans, chitosan, collagen, curdlan and other β-1,3-glucans, fig seed gum (galacturonan), gellan, hyaluronic acid, pectins, Rhizobium gum, Porphyridium cruentum polysaccharide, starch (amylose, amylopectin), acacia gum, gum arabic, chondroitin sulfates, dextrans, flaxseed gum, gum ghatti, inulin (fructan), karaya gum, larch arabinogalactan, levan (fructosan), cassia gum, tara gum, fenugreek gum, oat glucans, okra mucilage, psyllium seed gum, pullulan, quince seed gum, rhamsan, scleroglucan, succinoglucan, tamarind gum, gum tragacanth, wellan, and xanthan gum.

The hydrocolloid can be konjac glucomannan and a water-insoluble clarified konjac glucomannan film can be obtained by adding an appropriate amount of an alkaline agent to the clarified konjac glucomannan hydrocolloid and glycerin mixture. The hydrocolloid can be konjac glucomannan, aloe mannan or galactomannan and a hot water soluble film can be obtained by adding clarified xanthan to the hydrocolloid and glycerin mixture.

A rigid film can be obtained by omitting the glycerine or other plasticizer. A water-imbibing, amorphous gel-forming film can be obtained by adding borax to the hydrocolloid and glycerin mixture.

The invention also relates to a process of producing a clarified hydrocolloid foam comprising: (a) soaking a dispersed hydrocolloid containing material in water until the hydrocolloid is hydrated; (b) stirring the hydrated hydrocolloid until a homogenous particulate containing sol is obtained; (c) removing insoluble particulates from the particulate containing sol to produce a clarified sol; (d) removing remaining particulates in the clarified sol by filtration; (e) recovering clarified hydrocolloid from the filtrate; and (f) adding an appropriate amount of a suitable foaming agent to the clarified hydrocolloid sol, whipping the resultant mixture to produce a foam, adding a foam stabilizing reagent, and drying the foam.

The hydrocolloid can be selected from the group consisting of: konjac glucomannan, guar gum, locust bean gum, aloe mannan, agar, agarose, algins, β-, κ-, ι-carrageenans, chitosan, collagen, curdlan and other β-1,3-glucans, fig seed gum (galacturonan), gellan, hyaluronic acid, pectins, Rhizobium gum, cassia gum, tara gum, fenugreek gum and xanthan gum.

Glycerin can be added to the clarified hydrocolloid before the foaming agent is added. The hydrocolloid can be a glucomannan or galactomannan and xanthan and glycerin can be added to the clarified hydrocolloid before the foaming agent is added.

The invention is also directed to a process of producing a clarified konjac glucomannan hydrocolloid sponge comprising: (a) soaking a dispersed konjac glucomannan hydrocolloid containing material in water until the hydrocolloid is hydrated; (b) stirring the hydrated konjac glucomannan hydrocolloid until a homogenous particulate containing sol is obtained; (c) removing insoluble particulates from the particulate containing sol to produce a clarified sol; (d) removing remaining particulates in the clarified sol by filtration; (e) recovering clarified konjac glucomannan hydrocolloid from the filtrate; (f) adding alkali to the clarified sol, and heating to form a gel; (g) freezing the konjac glucomannan gel; and (h) thawing the frozen konjac glucomannan gel to produce a sponge. The filtrate of step (e) can be dried and ground into a powder and reconstituted with water before proceeding to step (f).

The invention also pertains to a process of borating a cis-1,2-diol containing hydrocolloid which comprises: (a) soaking a dispersed cis-1,2-diol containing hydrocolloid material in water until the hydrocolloid is hydrated; (b) stirring the hydrated hydrocolloid until a homogenous particulate containing sol is obtained; (c) removing insoluble particulates from the particulate containing sol to produce a clarified sol; (d) removing remaining particulates in the clarified sol by filtration; (e) recovering clarified hydrocolloid from the filtrate; and (f) dissolving the clarified hydrocolloid and reacting the clarified hydrocolloid with a borate containing agent.

The hydrocolloid can be konjac glucomannan, aloe mannan, guar gum, locust bean gum, cassia gum, tara gum, or fennugreek gum. Agar, gellan, carrageenan or curdlan can be added to the clarified hydrocolloid before cross-linking with the borate agent.

The invention is directed to a process of preparing a capsule of clarified hydrocolloid or mixtures of clarified hydrocolloids which comprises preparing a clarified hydrocolloid sol according to the invention and casting the sol as a film on a capsule forming template, drying the film and separating the formed capsule from the template.

The invention is also directed to a process of forming a low viscosity hydrocolloid sol by causing a particulate hydrocolloid to absorb hydrogen peroxide and then heating the hydrocolloid or permitting the hydrated colloid to remain at room temperature for an extended period.

The invention is also directed to a process of producing a reduced viscosity clarified konjac glucomannan sol which comprises adding hydrogen peroxide to a konjac glucomannan-containing solid, blending the mixture until a homogenous paste is obtained, heating the paste to about 65° C. for about five hours, cooling the mixture to about ambient temperature, adding a filter aid to the mixture, filtering the mixture to obtain a clear filtrate, adding isopropyl alcohol to the clear filtrate to precipitate konjac glucomannan, collecting the coagulated konjac glucomannan, drying the coagulated konjac glucomannan, and grinding it to form a powder.

The invention is also directed to a process of producing a hydrocolloid composite which, when hydrated, forms a clear hydrocolloid composite sol which comprises: (a) soaking a first dispersed hydrocolloid containing material in water until the hydrocolloid is hydrated; (b) stirring the hydrated hydrocolloid until a homogenous particulate containing sol is obtained; (c) removing insoluble particulates from the particulate containing sol to produce a clarified sol; (d) removing remaining particulates in the clarified sol by filtration; (e) recovering the first clarified hydrocolloid from the filtrate; (f) soaking a second dispersed hydrocolloid containing material in water until the hydrocolloid is hydrated; (g) stirring the hydrated hydrocolloid until a homogenous particulate containing sol is obtained; (h) removing insoluble particulates from the particulate containing sol to produce a clarified sol; (i) removing remaining particulates in the clarified sol by filtration; (j) recovering the second clarified hydrocolloid from the filtrate; (k) dispersing the first clarified hydrocolloid powder and the second clarified hydrocolloid in water; (l) mixing the dispersed first clarified hydrocolloid and the dispersed second clarified hydrocolloid to obtain a homogenous mixture; (m) coagulating the first hydrocolloid with the second hydrocolloid as a precipitate by adding a miscible alcohol; (n) collecting the coagulated hydrocolloid composite; and (o) drying the composite and grinding it to form a powder. The filtrates of steps (e) and (j) can be dried and ground into a powder and reconstituted with water before proceeding to step (k).

A sodium chloride solution can be included in step (k) to enhance coagulation. The miscible alcohol can be isopropyl alcohol. The dispersed in water first and second clarified hydrocolloids can be boiled to assist dispersion. A water soluble alkyl cellulose can be substituted for the second hydrocolloid, or added in addition to it.

The first clarified hydrocolloid can be konjac glucomannan. The second clarified hydrocolloid can be clarified guar sol, agar sol or xanthan sol. The first hydrocolloid can be clarified guar sol and the second hydrocolloid can be clarified xanthan sol. The invention includes preparing capsules of clarified hydrocolloid composites by casting the clarified composite sol as a film on a capsule forming template, drying the hydrocolloid composite and separating the formed capsule from the template.

The invention also pertains to a clarified hydrocolloid composite selected from the group consisting of clarified konjac and clarified guar gum which composition can form a clear sol when mixed with water, clarified konjac and clarified xanthan gum which composition can form a clear sol when mixed with water and heated, clarified xanthan gum and clarified guar gum which composition can form a clear sol when mixed with water and heated, a clarified aloe mannan and clarified guar gum which composition can form a clear sol when mixed with water, clarified konjac and clarified agar which composition can form a clear sol when mixed with water and heated, clarified aloe mannan and clarified konjac which composition can form a clear sol when mixed with water and heated, clarified konjac and clarified carboxymethyl cellulose which composition can form a clear sol when mixed with water, and clarified guar gum and clarified carboxymethyl cellulose which composition can form a clear sol when mixed with water, produced according to the process of the invention.

### DRAWINGS

In drawings which illustrate specific embodiments of the invention, but which should not be construed as restricting the spirit or scope of the invention in any way:

FIG. 1 illustrates a schematic flow sheet of various types of films that can be prepared from clarified konjac sol according to the invention.

FIG. 2 illustrates a schematic flow sheet of various types of films that can be prepared from clarified guar, locust bean gum or other galactomannan sol according to the invention.

FIG. 3 illustrates a schematic flowsheet of various types of foams that can be made from clarified konjac sol according to the invention.

FIG. 4 illustrates a schematic flowsheet of various types of foams that can be made from clarified guar or locust bean gum sol according to the invention.

FIG. 5 illustrates a schematic flowsheet of various types of sponges that can be made from clarified konjac sol according to the invention.

FIG. 6 illustrates a schematic flowsheet of various types of capsules that can be made from clarified hydrocolloid sols according to the invention.

### DETAILED DESCRIPTION OF INVENTION

Although there are a number of published procedures in the patent and journal literature for clarifying hydrocolloids, such as glucomannans, galactomannans, and fermentation polysaccharides, particularly for structure determination and derivatization, no clarified products having significant sales seem to be available commercially. This fact tends to demonstrate that none of these methods are cost-effective or, in some cases, capable of scale-up, or in other cases, the clarified hydrocolloids suffer a loss in properties, when compared to the unclarified hydrocolloids. In the case of locust bean gum and konjac, clarified products are manufactured by, for example, FMC Corporation to be sold as blends. Significant viscosity reduction is evident with their commercial products.

We have developed a simple but non-obvious process that results in dry hydrocolloid products that, when reconstituted, form clear viscous sols, free from essentially all particulates and retain desirable physical properties, unlike commercially available products. While we do not wish to be adversely bound by any theories, we offer the explanation that the unique method according to the invention appears to surmount the difficulties inherent with prior processes by minimizing heating and high-shear stirring in the dissolution step. This keeps the impurities in as large a particulate state as possible. The process follows with centrifuging to remove the filter-blinding materials, filtering the mixture at a temperature less than about 45° C., except when the polysaccharides are insoluble at this temperature, using an appropriate filter aid, recycling the filtrate until it is crystal clear, recovering the clarified hydrocolloid through isopropyl alcohol coagulation, and maintaining ready re-solubility in the clarified products with a final wash of high-titer alcohol. This procedure can be used to clarify virtually all hydrocolloids, including konjac, guar gum, locust bean gum, Aloe acemannan, and xanthan gum, to name a few.

The clarified hydrocolloids obtained by the method according to the invention can be recovered directly, such as by coagulation in isopropyl alcohol, or can be combined with one or more other hydrocolloid sols and then recovered. The process of the invention can impart unique properties to the composite clarified hydrocolloids that are different from the individual clarified hydrocolloids. Such properties cannot be achieved by direct blends of the solid materials. In one embodiment of the invention, a simple yet unique way for preparing low-viscosity, clarified depolymerized konjac has also been discovered and developed.

The products and process of the invention differ from the prior art in a number of respects. There are in existence a number of patents and publications that disclose procedures for “clarifying” konjac and other hydrocolloids. The products derived from most of these procedures are either unsatisfactory or the method is laborious and not cost-effective. Using the method according to the invention for clarifying polysaccharides, it is likely that cost-effective products can be obtained. These clarified polysaccharides can either be blended with other ingredients, co-precipitated with other hydrocolloids, or co-dried with other materials, leading to a number of interesting and useful, commercially feasible, clarified polysaccharide-based products.

The key inventive and successful factors with this process, and what makes it unique and different from existing konjac clarification processes, and other hydrocolloid clarification procedures, is a combination of the way the crude hydrocolloids are reconstituted to minimize the possibility for degradation or conversion to insoluble entities, maintaining the impurities in as large a particle size as possible, the centrifugation method used to remove the filter-blinding solids, the filtration, and the polysaccharide recovery. All these steps lead to retention or enhancement of viscosity and other desirable properties.

The use of hydrogen peroxide in a heterogeneous reaction, i.e., imbibing the peroxide into the dry konjac powder and allowing the reaction to take place until the mixture becomes fluid, also is unique.

### Clarifying Other Natural Polysaccharides

In addition to the polysaccharides mentioned in this discussion, there is no reason to believe that the following natural polysaccharides cannot be clarified using appropriate temperature and time modifications of the basic method. A non-limiting list follows.

Gelling

Agar, agarose, algins, β-, κ-, ι-carrageenans, chitosan, collagen, curdlan and other β-1,3-glucans, fig seed gum (galacturonan), gellan, hyaluronic acid, pectins, Rhizobium gum and Porphyridium cruentum polysaccharide.

Non-gelling

Acacia gum, gum arabic, λ-carrageenan, chondroitin sulfates, dextrans, flaxseed gum, gum ghatti, inulin (fructan), karaya gum, larch arabinogalactan, levan (fructosan), cassia, tara, fenugreek and other galactomannans, oat glucans, okra mucilage, psyllium seed gum, pullulan, quince seed gum, rhamsan, scleroglucan, starches (amylose, amylopectin), succinoglucan, tamarind gum, gum tragacanth, wellan, and xanthan gum.

Clarified hydrocolloids, prepared according to the invention, can be used individually or with one or more other hydrocolloids and/or other ingredients as thickeners or viscosifiers, gelling agents, film-formers, coatings, foams, sponges or capsules. Potential applications for these include the following: ingredients in foods, beverages, nutraceuticals, pharmaceuticals, tabletting aids, tablet coatings, encapsulating material, drug delivery substrates, diagnostics, cosmetics, personal care products, wound and burn care products, aqueous fluids absorbent, cell growth matrices, tissue engineering substrates, plant propagation supports, prosthetics, contact lenses, life sciences research, photographic film, and the like.

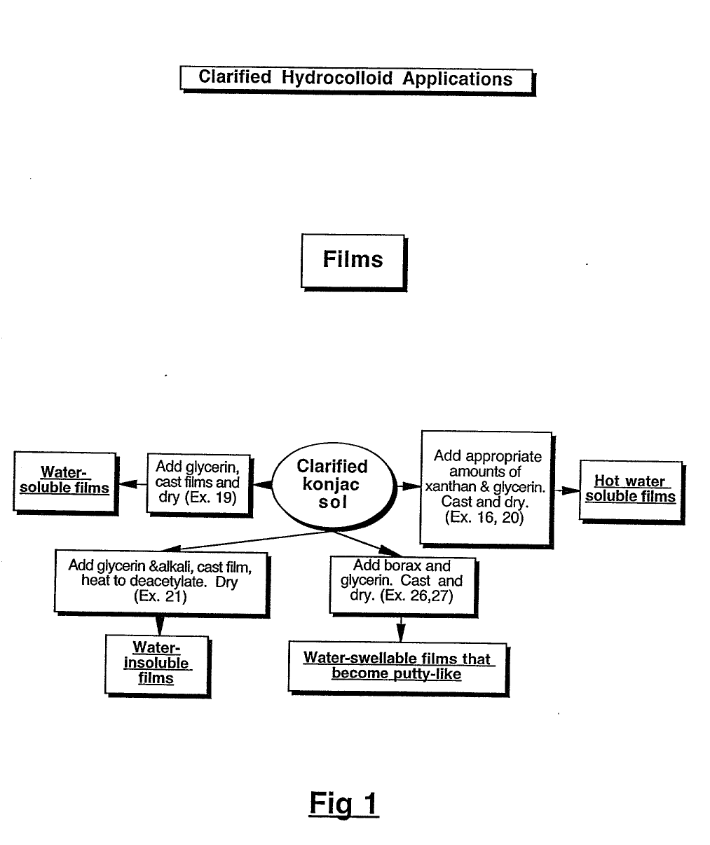

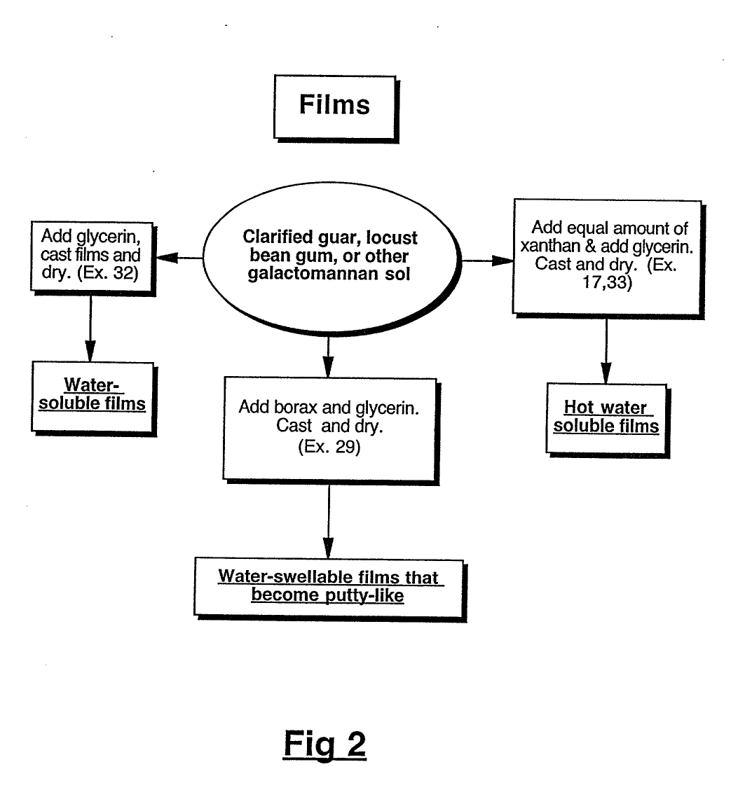

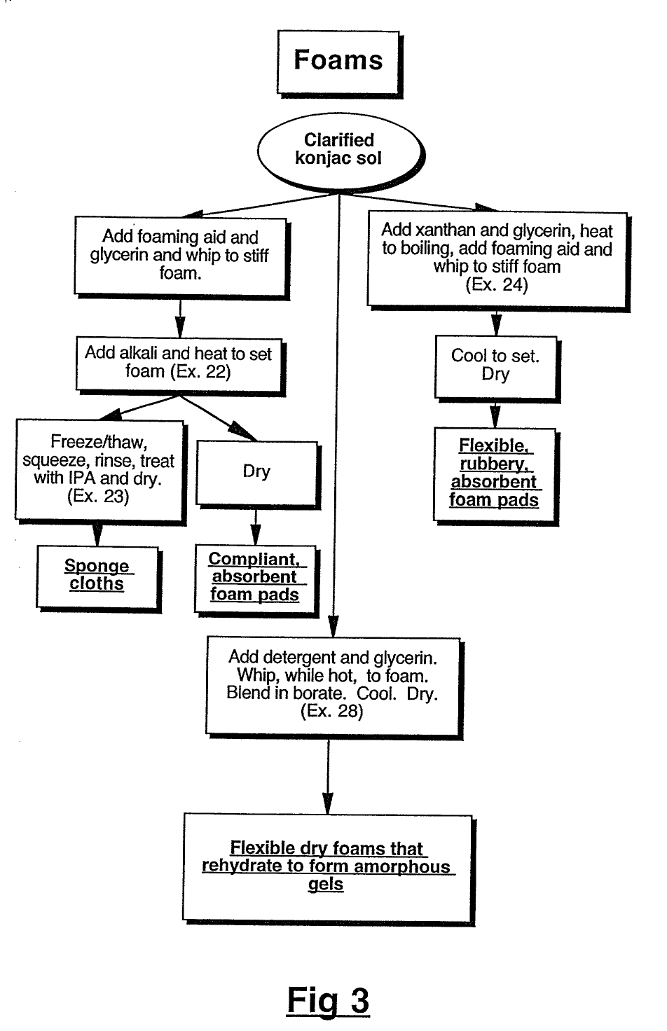

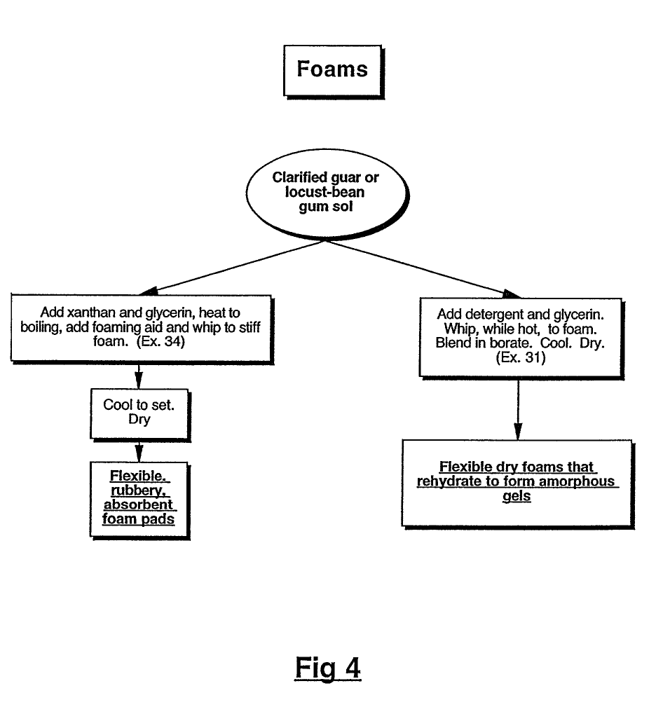

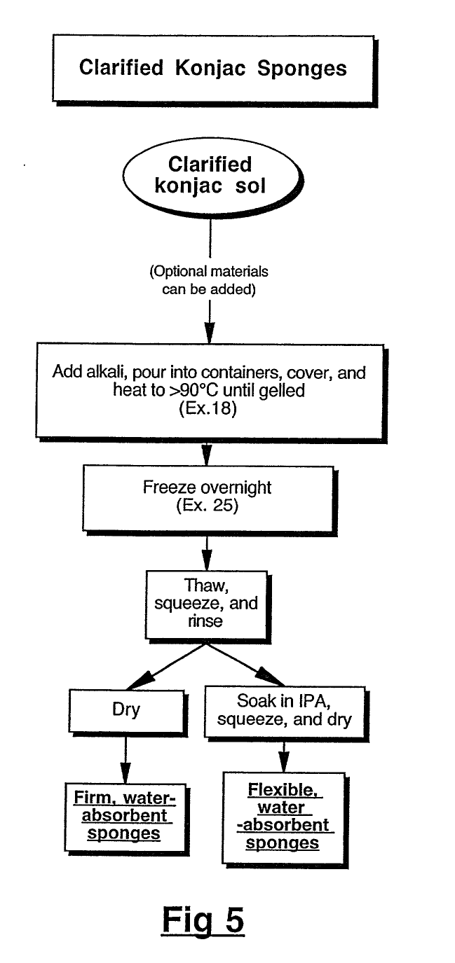

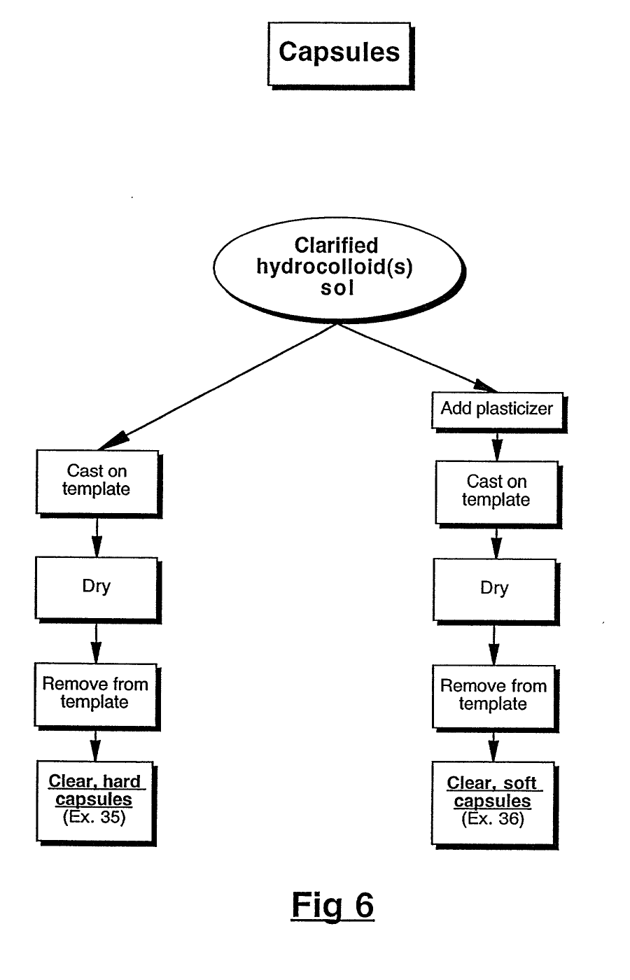

FIGS. 1 to 6 illustrate schematic flowsheets of various procedures that can be used to convert clarified hydrocolloids such as konjac, aloe mannan, guar gum and locust bean gum into films, foams, sponges and capsules. FIG. 1 illustrates a schematic flow sheet of various types of films that can be prepared from clarified konjac sol according to the invention. FIG. 2 illustrates a schematic flow sheet of various types of films that can be prepared from clarified guar, locust bean gum or other galactomannan sol according to the invention. FIG. 3 illustrates a schematic flowsheet of various types of foams that can be made from clarified konjac sol according to the invention. FIG. 4 illustrates a schematic flowsheet of various types of foams that can be made from clarified guar or locust bean gum sol according to the invention. FIG. 5 illustrates a schematic flowsheet of various types of sponges that can be made from clarified konjac sol according to the invention. FIG. 6 illustrates a schematic flowsheet of various types of capsules that can be made from clarified hydrocolloid sols according to the invention.

### EXAMPLES

Although isopropyl alcohol (2-propanol) coagulation has been used as the recovery method in many of the examples given, it is conceivable that other methods, such as spray drying, freeze drying, etc., can be used as well, to recover the clarified polysaccharides and composites.

### Clarification Procedures

### Clarified Konijac (High Viscosity)

### Example 1

(Using NaCl (ag.) to Dissolve the Konjac, Direct Filtration)

(MBI Notebook DWR1, p. 38):

Using a 2-liter Pyrex measuring bowl, 10 grams of AMOPHOL LG konjac powder (Shimizu Chemical Corp., lot LHB27) was dispersed in 1 liter of deionized water (tap water may be satisfactory) containing 25 grams of dissolved NaCl using a hand-held Braun blender/homogenizer to assure complete dispersion and minimize clumping. The container was covered with plastic film and the contents heated to boiling in a microwave oven. Occasional hand-stirring with a spatula was needed initially to keep the swelling particles from settling. The hot mixture, containing both dissolved konjac and swollen particles as well as particulate impurities, was allowed to cool to near room temperature. A brief high shear blending with the Braun Blender was used to assist in the dissolution of the swollen particles. Fifty grams of Dicalite SpeedPlus filter aid was added, along with 500 ml of de-ionized water. The mixture was blended briefly (Braun Blender), then filtered through a cloth pad in a 2-liter pressure filtration device, recycling until crystal clear. The clear filtrate was collected (^{˜}1400 ml) and then coagulated in 3 liters of 85% isopropyl alcohol (IPA)(aq.). After 1/2 hour, the white, voluminous fibrous coag was collected on fine-mesh Nitex cloth, squeezed, pulled apart, washed in 500 ml 60% IPA for 1/2 hour using magnetic stirring, again collected on Nitex, squeezed, pulled apart, and washed, with magnetic stirring in 500 ml of 99% IPA. The washed, clarified konjac fibers were again collected on Nitex cloth, squeezed, then pulled apart and dried in a forced air oven at about 40° C. The dried, fluffy white product, 7.4 g or 74% yield, without moisture correction, was ground to -20 mesh. A clear 0.5% sol was formed when this material was dissolved in 0.5% NaCl(aq.) A 1% sol in de-ionized water exhibited a viscosity of 10,870 mPas at 25° C., using the #2 spindle and 0.3 rpm settings on the Brookfield DV-II+ Viscometer. An equivalent concentration of the starting material (1.35% based on 74% yield) had a viscosity of 5,250 mPas at 22° C., #2 spindle, 0.3 rpm.

### Example 2

(MBI Notebook DWR1, pp. 16, 26, 29, 32, 36, 37):

In a similar manner other konjac flour-based products from Shimizu Chemical Industries, AMOPHOL TS, PROPOL RS, and PROPOL RX-H were clarified. Yields obtained were 72.0%, 65.5%, and 58.2% respectively.

### Example 3

(No Salt, No Centrifugation) (MBI Notebook DWR1, p.46):

Five grams of AMOPHOL TS (Lot TGJ22, Shimizu Chemical Corporation) was dispersed in 0.5 liters of de-ionized water using a spatula. The mixture was heated to boiling in a microwave oven. An additional 250 ml of de-ionized water was added and stirred in using an Arrow overhead stirrer. To this was added 25 grams of Dicalite Speed Plus filter aid and stirred until homogeneous. This was filtered at room temperature through a thick cloth pad in a 2-liter pressure filtration apparatus (PFA). Only 200 ml of clear filtrate was collected before a tough film blinded the filter. The filtrate was coagulated in 400 ml of 85% IPA, stirring with a spatula while pouring. After one-half hour, the coag was collected on Nitex cloth, squeezed, and washed by stirring with 200 ml of 60% IPA for 20 minutes, again collecting on Nitex cloth and squeezing. 200 ml of 99% IPA was used for the final wash After collecting and squeezing, the coag was dried at about 38° C. in a one-pass hot air oven. After grinding to −20 mesh, 0.4 g (about 60% yield) of white powder was obtained.

In a like manner, 10 g of Konjac Flour M (Shimizu Chemical Corporation, Lot 981027) was clarified with 6.37 g (63.7% yield) being obtained. The viscosity of a 1% sol of the clarified material was 1,156 mPas compared with a 1% viscosity of 656 mPas for the Konjac Flour.

### Example 4

(Water, Centrifugation, Filtration) (MBI Notebook DWR3, p10)

Filtration difficulties were encountered with direct filtration of the konjac sol because of the formation of a waxy flexible film on the surface of the filter aid. The procedure was modified to include a centrifugation step before filtration. Filtration of the combined centrifugates was rapid and able to be done at low pressure input.

To 1 liter of de-ionized water was added 6.7 g of Konjac Flour AP (Shimizu Chemical Corporation, Lot 990820) and dispersed using a wire whisk attachment on a Braun hand-held blender. After standing at room temperature for about one hour to hydrate, the high-shear blade attachment to the Braun blender was used to prepare a smooth sol. This sol was distributed into 4 screw-cap polypropylene centrifuge bottles and centrifuged at 11,000 rpm for 40 minutes, using a Sorvall RC2-B centrifuge. After the supernatants were removed by decantation and combined, 50 g of Dicalite Speed Plus filter aid was added and mixed in thoroughly. This was filtered through a felt pad in a 2-liter pressure filtration device. Filtration was rapid and accomplished at <20 psi. The filtrate (800 ml) was sparkling clear. To this was added 500 ml of 99% IPA and the stirred with a spatula to mix thoroughly. A mucoid coag formed which on standing became firm enough to handle. This was collected on Nitex cloth, squeezed, pulled apart and washed in 300 ml of 99% IPA and again collected on Nitex cloth, squeezed and dried at about 38° C. in a one-pass hot air oven. After grinding to −20 mesh, 2.38 g (about 35.5% yield) of white powder was obtained. A 1% sol in de-ionized water was clear and exhibited a viscosity of 8,125 mPas at 21.3° C., using the #2 spindle and 0.3 rpm settings on the Brookfield DV-II+ Viscometer. Conductivity was 20 μS at 21.5° C. using an Oakton TDSTestr™ conductivity meter.

Two pilot plant scale-ups of this procedure yielded white powders having viscosities of 25,250 and 29,030 mPas respectively for 1% sols compared with 32,500 for a 1.35% sol of the Konjac Flour AP.

### Clarified Partially De-polymerized Konijac (Low Viscosity)

### Example 5

(MBI Notebook3, pp. 2,4.)

To 350 g of AMOPHOL TS (Shimizu Chemical Corporation, Lot THF 19) in a stainless steel 5-quart Kitchen Aid mixing bowl was added 1400 ml of 10% hydrogen peroxide and the mixture blended until it became a stiff homogeneous paste. The bowl was covered with Saran Wrap and placed in a 65° C. water bath for 5 hours, occasionally mixing with a spatula. During this time a nearly clear, slightly yellow, low-viscosity fluid was obtained. After allowing the reaction product to cool to room temperature, 25 g of Dicalite Speed Plus filter aid was added and mixed in with a broad spatula. This mixture was filtered through a 30 g pre-coat of the filter aid on a felt pad in a 2-liter pressure filtration device. The clear filtrate (ca. 1500 ml) was coagulated in 4.5 liters of rapidly stirring 99% IPA. The fine precipitate was collected on Nitex cloth, squeezed, washed for 20 minutes in 4 liters of stirred 99% IPA, collected on Nitex cloth, squeezed, and dried at about 38° C. in a one-pass hot air oven. 299.5 g (86.5%) of fine white granular powder was obtained. A clear 10% solution (w/w) of this material in de-ionized water was easily prepared. Properties of this 10% solution were as follows: viscosity=1.4 mPas, pH=2.98, turbidity=16.4 N.T.U.

### Clarified Guar Gum

### Example 6

(MBI Notebook DWR3, p.33)

Commercial grade guar gum, PROCOL F (Lot:A7265B), was obtained from Polypro International, Minneapolis, Minn. To 10 g was added 30 ml of 99% IPA and the mixture stirred with a spatula until homogeneous. While agitating with the wire whisk attachment to a Braun hand-held blender, one liter of de-ionized water was added rapidly and stirred until nearly homogeneous. After standing at room temperature for one hour to complete hydration, the mixture was heated to boiling using a microwave oven then homogenized using the blender attachment. The mixture was reheated to boiling and transferred to 2-250 ml polypropylene screw-cap centrifuge bottles and centrifuged for 30 minutes at 11,000 rpm, using a Sorvall RC2-B centrifuge. After the supernatants were removed by decantation and combined, 25 g of Dicalite Speed Plus filter aid was added and mixed in thoroughly. This was filtered through a 30 gram pre-coat of the Speed Plus on a felt pad in a 2-liter pressure filtration device. The filtrate (ca. 800 ml) was sparkling clear. This was coagulated in 800 ml of rapidly stirring 99% IPA. The coag was collected on Nitex cloth, squeezed, pulled apart and washed in 250 ml of 99% IPA and again collected on Nitex cloth, squeezed and dried at about 38° C. in a one-pass hot air oven. After grinding to −20 mesh, 4.65 g (46.5% yield) of white powder was obtained. The 1% sol viscosity of clarified guar was >2,000 mPas compared with 2,575 mPas for a 1% sol of the PROCOL F.

### Clarified Locust Bean Gum

### Example 7

(MBI Notebook DWR1, p.43)

Using a Braun hand-held mixer, 2 g of commercial locust bean gum (T.I.C. Gums, Por/A, FCC Powder, Lot: P00124) was suspended in 300 ml of de-ionized water containing 2 g of NaCl. This was covered with Saran Wrap and heated to boiling in a microwave oven. The mixture was re-blended, 10 g of Dicalite SpeedPlus filter aid was added and mixed in thoroughly. This was then filtered through a 10 g pre-coat of the filter aid on a felt pad in a 500 ml pressure filtration vessel, recycling until sparkling clear. The clarified locust bean gum was recovered by coagulating the filtrate (ca. 250 ml) in 500 ml of 85% IPA. The coag was collected on Nitex cloth, squeezed, and washed successively with 200 ml 60% IPA, and 200 ml of 99% IPA, each time stirring for 1/2 hour, then collecting the coag on Nitex cloth and squeezing. Drying was effected at about 38° C. in a one-pass hot air oven. After grinding to −20 mesh, 1.28 g (64% yield) of white powder was obtained. A 1% sol of the clarified locust bean gum was clear and colorless and exhibited a viscosity of 438 mPas compared with a 1% sol viscosity of 212 mPas for the starting material.

### Clarified Aloe Acemannan

### Example 8

(MBI Notebook DWR3, p.26):

To 5 g of Aloe glucomannan (Carrington Laboratories' acemannan 95008, Lot: 10608) was added sufficient 99% IPA to just wet the powder evenly when stirred with a spatula. Using the wire whisk attachment to the Braun hand-held mixer, 750 ml of de-ionized water was added. The dispersed suspension was allowed to stand until fully hydrated. The mixture was brought to a boil in a microwave oven and blended using the blender attachment to the Braun. This sol was distributed into 3-250 ml screw-cap polypropylene centrifuge bottles and centrifuged at 10,000 rpm for 30 minutes, using a Sorvall RC2-B centrifuge. After the supernatants were removed by decantation and combined, 25 g of Dicalite Speed Plus filter aid was added and mixed in thoroughly. This was filtered through a 30 g pre coat of the filter aid on a felt pad in a 2-liter pressure filtration device. The filtrate (650 ml) was clear but not sparkling. The clarified Aloe glucomannan was recovered by adding 650 ml of 99% IPA and mixing thoroughly. After standing at room temperature for an hour to harden, the coag was collected on Nitex cloth, squeezed, and washed using 300 ml 99% IPA stirring for 1/2 hour, then collecting the coag on Nitex cloth and squeezing. Drying was effected at about 38° C. in a one-pass hot air oven. After grinding to −20 mesh, 2.0 g (40% yield) of white powder was obtained. A 1% sol of the clarified Aloe glucomannan was clear and very viscous.

### Clarified Xanthan Gum

### Example 9

(MBI Notebook DWR2, p.7)

Ten grams of Keltrol T (Monsanto, Lot 8K0725K) was dispersed in one liter of deionized water using a Braun hand-held blender. Dissolution was completed by heating to boiling in a microwave oven. Twenty grams of Celite (3 micron) was added and dispersed uniformly. The mixture was brought to boiling and filtered through a 30 gram pre-coat in a pressure filtration device. About 920 ml of filtrate was collected. This was coagulated in 2 liters of 99% IPA after mixing in 20 ml of 10% NaCl. The coagulum was collected on Nitex cloth, squeezed, and placed in 500 ml of 85% IPA overnight. The coag was collected and dried at about 38° C. in a single-pass, forced air oven. The white product was ground to −20 mesh yielding 6.8 g (68%) of powder. The viscosity of a 1% sol was 3,000 mPas compared with a viscosity of 3,562 mPas for a 1% sol of the starting material.

### Co-precipitation (Hydrocolloid Composites)

The following examples are only a small part of the infinite number of combinations possible. Concentrations can be altered as can the materials for co-processing. Additionally, other soluble and/or insoluble materials can be included.

### Clarified Konjac/Carboxymethyl Cellulose (CMC)

### (3:1)

### Example 10

(MBI Notebook DWR2, p.63)

One liter of 1% clarified konjac (Marine BioProducts, Lot 268) sol, 335 ml of 1% CMC (Hercules, Cellulose gum Type 7MF PH, Lot 66989) sol, and 14 ml of 10% NaCl (aq.) solution were combined, mixed thoroughly with a Braun hand-held blender, then coagulated in 2.5 liters of rapidly stirred 99% IPA. The white stringy coag was collected on a fine sieve, squeezed to remove fluid, pulled apart, then washed by stirring with one liter of 99% IPA for 15 minutes. The washed coag was collected on Nitex cloth, squeezed, then dried in a forced-air oven at about 38° C. After grinding to −20 mesh, 10.7 g (80.1% yield) of white product was obtained. This was more readily soluble in water than was the clarified konjac control and rapidly formed a clear sol, almost spontaneously.

### Clarified Konjac/Hydroxyethyl Cellulose (HEC)

### (4:1)

### Example 11

(MBI Notebook DWR1, p.59):

One percent sols of clarified konjac (Marine BioProducts, Lot 257) and HEC (Hercules, Natrosol 250L NF, FP10, Lot 13879) were prepared. To 400 ml of the konjac sol was added 100 ml of the HEC sol, the two mixed together thoroughly using a Braun hand-held blender, heated to boiling, then coagulated in 1 liter of 85% IPA while stirring with a spatula. The coag was collected on a Nitex cloth, squeezed, then washed successively with 500 ml of 85% IPA for 20 minutes and 250 ml of 99% IPA for 10 minutes, each time stirring, then collecting on Nitex and squeezing to remove as much fluid as possible. Drying was done in a forced-air oven at about 38° C. After grinding to −20 mesh, 3.2 g (64% yield) of white product was obtained. This was more readily soluble in water than was the clarified konjac control and rapidly formed a clear sol.

### Clarified Konjac/Hydroxypropylmethyl Cellulose (HPMC)

### (4:1)

### Example 12

(MBI Notebook DWR1, p.59):

One percent sols of clarified konjac (Marine BioProducts, Lot 257) and HPMC (Hercules, Benecel MP-824, FP10, Lot 13510) were prepared. To 240 ml of the konjac sol was added 60 ml of the HPMC sol, the two mixed together thoroughly using a Braun hand-held blender, heated to boiling, then coagulated in 500 ml of 85% IPA while stirring with a spatula. The coag was collected on a Nitex cloth, squeezed, then washed successively with 300 ml of 85% IPA for 20 minutes and 300 ml of 99% IPA for 10 minutes, each time stirring, then collecting on Nitex and squeezing to remove as much fluid as possible. Drying was done in a forced-air oven at about 38° C. After grinding to −20 mesh, 1.3 g (43.3% yield) of white product was obtained. (The low yield is due to the fact that HPMC is some-what soluble in the alcohol concentrations used.) The konjac/HPMC composite was more readily soluble in water than was the clarified konjac control and rapidly formed a clear sol.

### Clarified Konjac/Clarified Locust Bean Gum

### Example 13

(MBI Notebook DWR2, p.50)

Twenty milliliters each of 1% clarified konjac sol (Marine BioProducts, Lot 268) and 1% clarified locust bean gum (Marine BioProducts, DWR343B) were prepared using de-ionized water. These were combined, mixed thoroughly, heated to boiling in a microwave oven, and coagulated in 100 ml of 85% IPA. The coag was collected on Nitex cloth, squeezed, pulled apart, and washed by stirring for ten minutes with 100 ml of 85% IPA. After collecting on Nitex cloth, squeezing, and pulling apart, the washed coag was dried in a one-pass hot air oven at about 38° C., then ground to −20 mesh (0.31 g, 77% yield).

### Clarified Konjac/Clarified Guar

### (3:1)

### Example 14

(MBI Notebook DWR3, p.19)

To 100 ml of clarified guar (Marine BioProducts, DWR2-21-1) sol was added 300 ml of a 1% aqueous sol of clarified konjac TS (Marine BioProducts, Lot 268), the sols mixed well with a spatula and then coagulated in 800 ml of 99% IPA while stirring with a spatula. The fibrous white coag was collected on Nitex cloth and squeezed to remove adhering fluid. After washing in 500 ml of 99% IPA for 0.5 hours, the coag was collected, squeezed, then dried in a one-pass hot air oven at about 38° C. The coag was ground to −20 mesh, giving 3.55 g (88.8% yield) of white powder. When placed in water it hydrated rapidly and dissolved.

### Clarified Konjac/Agar

### (1:1)

### Example 15

(MBI Notebook DWR2, p.78)

One liter aqueous sols each of clarified konjac (Marine BioProducts, Lot 268) and agar (Marine BioProducts, Lot 276) were prepared. Both were heated to near boiling using a microwave oven, mixed thoroughly along with 30 ml of 10% NaCl (aq.). The composite was recovered by pouring into 5 liters of rapidly stirring 85% IPA. The white, fibrous coag was shredded using a Braun hand-held blender, then collected on Nitex cloth and squeezed to remove the adhering fluid. The coag was washed successively using 2 liters of 85% IPA then 1.5 liters of 99% IPA, each time stirring 20 minutes, collecting on Nitex and squeezing. Drying was done at about 38° C. in a one-pass forced air oven. After grinding to −20 mesh, 30.0 g (75% recovery) of white powder was obtained. A 1% gel prepared from this powder was elastic, nearly clear and colorless.

### Clarified Konijac/Xanthan

### (1:1)

### Example 16

(MBI Notebook DWR2, p.78)

One and a half liters each of 1% aqueous sols of clarified konjac (Marine BioProducts, Lot 268) and xanthan (Monsanto, Keltrol T, Lot 8K0725K) were prepared and heated to boiling. These sols were combined, along with 30 ml of 10% NaCl, mixed thoroughly while hot using a Braun hand-held blender, then coagulated by pouring into 6 liters of rapidly stirring 85% IPA. The fibrous white coag was collected on a fine sieve, squeezed, and pulled apart. After washing by stirring for 20 minutes in 1 liter 85% IPA, the coag was again collected, squeezed to remove the adhering alcohol, pulled apart and dried on Nitex cloth in a one-pass 38° C. forced air oven. After grinding to −20 mesh, 28.3 g (94% yield) of off-white powder was obtained. This powder rapidly absorbed about 200× its weight of de-ionized water or about 50× its weight of 1% NaCl to form a particulate gel. When heated and cooled, a clear elastic gel was formed. Aqueous gels of 0.06% were prepared that had a Jello®-like consistency.

### Clarified Guar/Xanthan

### (1:1)

### Example 17

(MBI Notebook DWR4, p.7)

To a dry mixture of 2.5 g of clarified guar (MBI Lot DWR344-1) and 2.5 g of Keltrol T xanthan (Monsanto lot 8K0725K) was added about 10 ml of 99% isopropyl alcohol and the mixture was stirred to ensure complete wetting. While being stirred with an overhead stirrer, 500 ml of deionized water was added. After dispersion was complete, the mixture was heated to boiling in a microwave oven and 400 ml was coagulated in 1 liters of 99% IPA using a spatula to agitate the mixture. After standing for one hour at ambient temperature to harden the precipitate, the product was collected using a plastic sieve. After squeezing, the precipitate was transferred to 300 ml of 99% IPA and stirred for about 20 minutes. The precipitate was collected on a Nitex cloth, squeezed, and dried in a 38° C. single-pass, forced-air oven. After grinding to −20 mesh, 3.16 g of powder was obtained. When 50 ml of water was added to 250 mg of this sample, the water was rapidly absorbed to form a relatively clear, semi-coherent gel. When this was brought to boiling in a microwave oven, it dissolved rapidly to form a clear, viscous solution, which when cooled, formed a clear, elastic gel.

### Clarified Hydrocolloid Gels, Films, Foams, Sponges and Capsules

Deacetylated konjac gels, films, foams, sponges, beads, and other forms can be prepared when konjac glucomannan is heated with alkali, about pH=7.5-11. Deacetylation occurs and the resulting gel product is water insoluble and thermostable. If the gel formed by deacetylation is frozen and thawed, a tough, coherent spongeous mass is formed. Porosity of the sponges depends on the rate of freezing of the sols. Other hydrocolloids and soluble and/or insoluble materials can be included.

The deacetylated konjac films are boiling water insoluble and are formed from a clarified konjac sol by adding alkali before casting the film, then heating to ensure that deacetylation occurs. Films can be prepared from a clarified konjac/xanthan sol that are clear and hot water (>85° C.) soluble. If films are prepared from a clarified konjac sol without heating, they are cold water soluble.

### Clarified Konjac Gels

### Example 18

(MBI Notebook DWR3, p.65)

To 250 ml of a 1% clarified konjac sol (MBI Lot 268) was added 2.5 ml of 1M NaOH. This was blended quickly, yet thoroughly, using the wire whisk attachment of the Braun hand-held blender. This mixture was rapidly poured equally into three 100 ml beakers. These were covered with plastic wrap and placed in a 99° C. oven to deacetylate and form a gel. This gel was not completely clear like the starting konjac sol, but slightly hazy. Gels containing 0.5% and 0.25% clarified konjac were also prepared in this manner.

### Clarified Konjac Films

Water Soluble Films

### Example 19

(MBI Notebook DWR3, p.64)

To 300 ml of a 1% clarified konjac sol (MBI Lot 268) in deionized water was added 1.5 g of glycerol. After mixing well, the sol was brought to boiling in a microwave oven, let stand in a 99° C. oven for 15 minutes to deaerate and poured into three oblong plastic dishes (11 cm×18.5 cm). The sols were dried to films at about 38° C. in a one-pass forced air oven. These films were tough, flexible, and fully transparent. When wet with water, the film rapidly absorbed water and disintegrated, then gradually dissolved.

Hot Water Soluble Films

### Example 20

(MBI Notebook DWR3, p.64)

To 300 ml of a hot (<80° C.) aqueous 0.5% sol of 1:1 clarified konjac/xanthan (see Example 16) was added 1.5 g of glycerol and the mixture stirred thoroughly. After reheating to boiling, the sol was placed in a 99° C. oven for 15 minutes to deaerate, then poured into three oblong plastic dishes (11 cm×18.5 cm). The sols were dried to films at about 38° C. in a one-pass forced air oven. These films were tough, flexible, and fully transparent. When wet with water, the film rapidly absorbed water and became quite tough and elastic, while remaining transparent.

Water Insoluble Films

### Example 21

(MBI Notebook DWR3, p.64)

To 100 ml of a 1% clarified konjac sol (MBI Lot 268) in deionized water was added 0.5 g of glycerol, and 1.0 ml of 1M NaOH. After mixing thoroughly with the wire whisk attachment of the Braun hand-held mixer, the mix was poured into an oblong plastic dish (11 cm×18.5 cm). The dish was covered and placed in a 99° C. oven to set. The cover was removed and the dish placed in a 38° C., one-pass, forced air oven to dry. The resulting film was not completely transparent, but slightly hazy. It was tough and flexible and rapidly imbibed water, maintaining its toughness and flexibility.

### Clarified Konjac Foams

Water Insoluble Deacetylated

### Example 22

(MBI Notebook DWR3, p.63)

In the stainless steel bowl of a Kitchen Aid mixer was placed 300 g of 1% clarified TS konjac (MBI, Lot 268), 40 g of a 3% aqueous sol of hydroxyethyl cellulose (Hercules, Natrosol 250 m Pharm, Lot FP 10 13809) as a foaming agent, and 4 g of glycerol as a plasticizer. This was mixed using the standard paddle attachment. There was insufficient HEC to induce foaming so about 5 ml of a solution of hand-soap (unknown origin) shavings was added and after beating for about 10 minutes on high speed, a thick white foam resulted. Three ml of 1M NaOH was added and rapidly beat into the foam. The foam was portioned into a variety of plastic dishes, covered and placed into a 99° C. oven for about one hour to deacetylate the konjac and form a thermo-irreversible gel matrix. The syneresate was removed by decantation and three of the foams dried in a 38° C. one-pass forced-air oven. When a sample of the white foam was placed in deionized water, it hydrated rapidly.

Water Insoluble Deacetylated, Frozen and Thawed

### Example 23

(MBI Notebook DWR3, p.63)

The remaining three foams from Example 22 were placed, covered tightly, in a −18° C. freezer overnight. The frozen foams were thawed in hot running water and the water expressed from the jelly fish-like, tough foamy masses using a thumb and forefinger. The resulting partially de-watered foams were covered with 99% IPA and let stand for about 1 hour. The fluid was expressed by squeezing and the procedure repeated. These were then blotted between paper towels and dried on a rack in the hood. The resulting white parchment-like sheets rapidly hydrated to form tough jelly fish-like masses.

### Clarified Konjac/Xanthan Foams

### Example 24

(MBI Notebook DWR3, p.72

Three hundred milliliters of a hot sol containing 3.0 g of 1:1 clarified konjac/xanthan and 1 g of glycerol was prepared in a 2-liter measuring bowl. This was placed in a boiling water bath and 2 ml of a solution of hand-soap shavings in deionized water was added. The mixture was then foamed using the wire whisk attachment on a Braun hand-held mixer. The foam was distributed into plastic dishes at room temperature. Setting was rapid. The foams were removed from the dishes and placed on a rack in a 38° C. one-pass forced air oven to dry. Rehydration in water was rapid and a voluminous, low strength, clearish foamy mass resulted. In 1% NaCl, rehydration was slower and resulted in a significantly lower volume, stronger, elastic hydrated foam.

### Clarified Konijac Sponges

### Example 25

(MBI Notebook DWR3, p.65)

The gels from Example 18 were placed in a −18° C. freezer overnight to freeze. They were then thawed using warm running tap water. The 1% gel/sponge had very small pores and was too firm to squeeze to fully convert to a sponge. The lower percentage gels, when frozen and thawed, gave jellyfish-like sponges. When soaked in 99% IPA, squeezed and dried, parchment like disks were obtained that imbibed water, but more slowly and to a lesser extent than the frozen, thawed, and dried foams.

### Clarified Hydrocolloid/Borate Interaction Products

Preparation of these amorphous solids consists of forming a sol of the cis 1,2-diol, and thermostable additives, if any, by dispersing the components in cool water, heating the mixture to boiling, adding hot aqueous sodium tetraborate, and allowing to cool. Other components can be added at suitable temperatures. If film preparation is desired, the hot sol can be distributed on a surface to form a film and the film used as is or dried For powders or granules, the solid diol can be triturated with a concentrated solution of sodium tetraborate with or without glycerol. For in situ-formed coatings, the sponge, cloth, gauze, or other material to be coated can either be dipped into the hot mix, removed and drained, and optionally dried. Alternatively, the coatings can be applied by successively dipping the material to be coated into the borate solution, draining, blotting, blowing, or squeezing to remove the excess, if desired; dipping next into a cis-1,2-diol polymer solution, with or without additives; and finally again into the borate solution. If desired, this series can be repeated.

Possible additives to the polymeric cis-1,2-diol reaction mixture used for any of the products are: other borate-reactive and/or non-reactive hydrocolloids; reactive or non-reactive low molecular weight substances; insoluble particulates, both swellable and non-swellable, including charcoal and encapsulated chemical and/or biological reagents, ion-exchange resins, etc.; therapeutics; enzymes; antibodies; antimicrobials; etc.

Gelling hydrocolloids, such as agar, gellan, carrageenan, and curdlan can be added to the clarified konjac, guar, locust bean gum, or aloe mannan sols before cross-linking with borate. At concentrations where the hydrocolloid would have formed a firm gel alone, combinations can yield products with unique properties.

The following two examples are not meant to be limiting, since many different combinations of cis-1,2-diol containing molecules will cross-link using borates and can be combined with each other and/or non-reactive molecules to give unique properties. In addition, glycerol and/or other compatible plasticizers can be added and clear, hydratable films prepared.

### Clarified Konjac/Borate Interaction Products

“Gels”

### Example 26

(MBI Notebook DWR3, p.73)

To three 50-ml samples of 1% clarified konjac (MBI, lot 268) in deionized water was added selected amounts of a 3.79% borax solution (=2.0% NaB₄O₇). After mixing thoroughly with a spatula, they were covered with plastic wrap and heated to boiling in a microwave oven, stirred again, and allowed to cool to room temperature. The following observations were made:

| ml borax | Observations (all clear and colorless) |
|---|---|
| 1 | mucoid consistency and slimy feel (free konjac) |
| 5 | flexible and slightly moist |
| 15 | firmer and slightly fragile |

Films

### Example 27

(MBI Notebook DWR3, p.73)

Films were prepared from the gels in Example 26 by adding a small amount of glycerol, heating to boiling in a microwave oven, mixing thoroughly and pouring into 11 cm×18.5 cm Rubbermaid™ plastic dishes. The gels were dried to films using a 38° C. one-pass, forced-air oven. Clear flexible films resulted that rapidly hydrated in deionized water.

Foam

### Example 28

(MBI Notebook DWR3, p.73)

To 50 ml of the 1% clarified konjac sol (see Example 26) was added 1 ml of a hand-soap shavings sol and the mixture whipped to a stiff foam using the wire whisk attachment of the Braun hand-held blender. Two milliliters of the 3.79% borax solution was added and whipped in. A very elastic foam resulted. This was placed on inverted plastic dishes and dried using a 38° C. one-pass, forced-air oven. A thin whitish dried foam resulted that hydrated rapidly in deionized water to a tough, elastic thin foam.

### Clarified Guar/Borate Interaction Products

“Gels”

### Example 29

(MBI Notebook DWR3, p.73)

To three 50-ml samples of 1% clarified guar (MBI, lot DWR3-33-1) in deionized water was added selected amounts of a 3.79% borax solution (=2.0% NaB₄O₇). After mixing thoroughly with a spatula, they were covered with plastic wrap and heated to boiling in a microwave oven, stirred again, and allowed to cool to room temperature. The following observations were made:

| ml borax | Observations (all clear and colorless) |
|---|---|
| 1 | flexible and slightly fragile |
| 5 | flexible and fragile |
| 15 | firmer and fragile |

Films

### Example 30

(MBI Notebook DWR3, p.73)

Films were prepared from the gels in Example 29 by adding a small amount of glycerol, heating to boiling in a microwave oven, mixing thoroughly and pouring into 11 cm×18.5 cm Rubbermaid™ plastic dishes. The gels were dried to films using a 38° C. one-pass, forced-air oven. A clear flexible film resulted from the first gel that was lowest in borate. The other two formed more brittle films. All hydrated rapidly in deionized water, became putty-like, and gradually dissolved when excess water was present.

Foam

### Example 31

(MBI Notebook DWR3, p.73)

To 50 ml of the 1% clarified guar sol (see Example 29) was added 1 ml of a hand-soap shavings sol and the mixture whipped to a stiff foam using the wire whisk attachment of the Braun hand-held blender. One milliliter of the 3.79% borax solution was added and whipped in. A very elastic foam resulted. This was placed on inverted plastic dishes and dried using a 38° C. one-pass, forced-air oven. Thin, whitish dried foams resulted that hydrated rapidly in deionized water to a tough, elastic thin foam that, over a period of time, continued swelling.

### Clarified Galactomannan Films (Water Soluble)

### Example 32

(MBI Notebook DWR4, p. 72).

In a manner analogous to Example 19, 1.35 g of glycerol was added to 300 ml of a 1% clarified guar sol prepared in deionized water. After mixing well, the sol was brought to boiling in a microwave oven, let stand in a 99° C. oven for 15 minutes to deaerate and poured into three oblong plastic dishes (11 cm×18.5 cm). The sols were dried to films at about 38° C. in a one-pass forced air oven. These films were tough, flexible, and fully transparent. When wet with water, the film rapidly absorbed water and disintegrated, then gradually dissolved.

If clarified locust bean gum is substituted for guar, similar films result.

### Clarified Galactomannan/Xanthan Films (Hot Water Soluble)

### Example 33

(MBI Notebook DWR4, p. 7)

A clear, hot water soluble film was prepared using the 1:1 guar/xanthan composite sol described in Example 17. After adding 0.5 g of glycerin and 100 ml of deionized water, the remaining sol (100 ml) was heated to boiling in a microwave oven and distributed equally into each of two oblong Rubbermaid™ plastic storage dishes and dried in a single pass, forced-air oven. The clear, flexible films rapidly absorbed ambient temperature water and became weak and swollen. In hot water, they dissolved.

If clarified locust bean gum is substituted for the guar, similar films result.

### Clarified Galactomannan/Xanthan Foams

### Example 34

In a manner analogous to Example 24, three hundred milliliters of a hot sol containing 3.0 g of 1:1 clarified guar/xanthan and 1 g of glycerol is prepared in a 2-liter measuring bowl. This is placed in a boiling water bath and 2 ml of a solution of hand-soap shavings in deionized water is added. The mixture is then foamed using the wire whisk attachment on a Braun hand-held mixer. The foam is distributed into plastic dishes at room temperature. Setting is rapid. The foams are removed from the dishes and placed on a rack in a 38° C. one-pass forced air oven to dry.

If clarified locust bean gum is substituted for the guar, similar foams result.

### Application of the Clarified Hydrocolloids to Capsule Formation and Encapsulation Techniques

Capsule Formation

Clarified hydrocolloids afford new opportunities in the fields of capsule formation, encapsulation, and particle coating, including controlled release. Capsules made from natural, plant-origin, clarified polysaccharides offer a viable alternative to the animal-origin gelatin-based capsules. The spontaneous cross-linking that occurs with gelatin is not an inherent property with most polysaccharide systems and should result in retention of the desirable characteristics. Many commercially available polysaccharides, because of the particulate materials they contain, cannot be used for capsule applications, particularly if clear capsules are essential. However, mixtures containing hydrocolloids that form clear sols (natural, semi-synthetic, and/or synthetic), such as disclosed herein, can be used.

The particular clarified hydrocolloid or hydrocolloid system that is chosen will depend on the properties desired for the finished capsule(s). Properties such as permeability, solubility, drug release, and disintegration time, to name a few, can be varied by using appropriate hydrocolloids and other components.

Because the viscosity of the hydrocolloid sols limit the concentrations that can be used, fillers can be added to increase the total solids concentration. These fillers can be the lower molecular weight fragments of the same hydrocolloid, or other low molecular weight hydrocolloids, or a combination.

Plasticizers can be added to impart flexibility to the capsules. These plasticizers can be glycerin, propylene glycol, polyethylene glycols, polypropylene glycols, or sorbitol, to name a few, or combinations thereof.

Other soluble and/or insoluble materials can be added to impart specific functionality to the capsules. These can act as gates to let in body fluids to release the capsule contents in a controlled manner.

Formation of the capsules from gelling formulations can be made using a self-gelling composition, sequential dipping in a sol of one hydrocolloid and then another synergistic one or another gelling agent.

Fixatives, such as formaldehyde, glyoxal, and/or other suitable cross-linking agents can be used to impart water insolubility to the capsules.

Encapsulation

Encapsulation involves film formation around a desired substance. A wide variety of clarified hydrocolloids and mixtures containing clarified hydrocolloids can be used. Various formulations for film formation have been demonstrated in Examples 19-21, 27, 30, 32 and 33 herein. These are but a few of the formulations that can be used for encapsulation and are not meant to be limiting in any way.

### Clarified Hydrocolloid-based Capsule Formation Examples

Depending on the properties desired for the dry capsule, there are many combinations of different hydrocolloids, different types of the same hydrocolloid, concentrations and relative concentrations of hydrocolloids, plasticizers, fillers, disintegrating agents, insoluble particulates, etc., that can be used in the formulations. The following examples of capsule formation are presented for illustration purposes with the understanding that they are non-limiting.

### Hard Capsules

### Example 35

(MBI Notebook DWR4, p. 71)

Clarified Guar/Agar:

To a dry mixture of 0.40 g of clarified guar (MBI DWR-36-1) and 0.40 g of agar (MBI NA#4C) was added about 3 ml of 99% isopropyl alcohol and the mixture stirred thoroughly with a spatula to ensure that each particle was wetted with the alcohol. Forty milliliters of deionized water was added, while stirring vigorously with a magnetic stirrer, and stirring continued until the guar was uniformly hydrated. The mixture was covered with plastic wrap, heated to boiling in a microwave oven, and placed in a boiling water bath. Approximately 4-inch lengths of 3/16″ and 1/4″ diameter Acetron® plastic rods ground to rounded ends were used for capsule formation. For each capsule, a rod was dipped in the hot sol to a depth of approximately 1/2″, then withdrawn and rotated in the air to obtain near-uniformity while the sol gelled. Occasionally, more of the hot sol was added to the rod, using a spatula, and slow twirling upside-down was continued until the gel set. The unused end of the rod was placed in a small beaker and then the gel was dried in a one-pass forced air oven at about 40° C. When dry, a cut was made through the dried capsule around the rod with a sharp knife at about 1/4″ from the end. Using a firm rotary motion of the rod and holding the capsule between the thumb and index finger, it was slipped off the rod. The capsules were firm and clear.

In a like manner, clear capsules composed of clarified guar/xanthan, agar/clarified konjac, clarified konjac/xanthan, and clarified low viscosity konjac/xanthan, according to the invention, were prepared. Many other formulations are possible.

### Soft-gel Capsules

### Example 36

(MBI Notebook DWR4, p. 71)

### Clarified Guar/Xanthan/Glycerin:

To 1 g of a 1:1 clarified guar/xanthan composite (MBI DWR4-7-1) was added about 5 ml of 99% isopropyl alcohol to wet the material. With rapid magnetic stirring, 45 ml of deionized water containing 0.5 g glycerin was added. Stirring was continued until the mixture was evenly hydrated. The beaker was covered with plastic wrap and the contents heated to boiling in a microwave oven during which time the mixture became a clear sol. This was placed in a boiling water bath to maintain the fluid state. Capsule formation was the same as described in Example 35, except that the dried capsule was strongly adhered to the rod. Instead of cutting 1/4″ from the end, 1/8″ cuts were made and the capsules were peeled from the template rods. The capsules were clear and flexible.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A process of producing a clarified konjac glucomannan gel or sponge, or clarified konjac glucomannan or clarified aloe mannan film, foam or capsule comprising:
(a) soaking dispersed konjac glucomannan or aloe mannan in water until the konjac glucomannan or aloe mannan is hydrated; stirring the hydrated konjac glucomannan or aloe mannan until a homogenous particulate containing sol is obtained; removing insoluble particulates from the particulate containing sol to produce a clarified sol; recovering clarified konjac glucomannan or aloe mannan from the filtrate; and drying and grinding it to a powder, and as required, dissolving the powder in water to form a sol;
(b) when a konjac glucomannan gel is required, adding an appropriate amount of a suitable alkaline agent to a sol of the clarified konjac glucomannan of step (a) to deacetylate the sol to form a gel;
(c) when a flexible water soluble film is required, adding an appropriate amount of glycerol or other plasticizer to a sol of the clarified konjac glucomannan or aloe mannan of step (a), dissolving the konjac glucomannan or aloe mannan, glycerol or other plasticizer mixture, casting the mixture as a film, and drying the film;
(d) when a flexible hot water soluble film is required, adding an appropriate amount of xanthan and glycerol or other plasticizer to the clarified konjac glucomannan or aloe mannan sol of step (a) to form a mixture, dissolving the mixture, casting the mixture as a film, cooling the film to a gel and drying the gel to form a film;
(e) when a flexible water-insoluble film is required, adding an appropriate amount of glycerol or other plasticizer and alkaline agent to the clarified konjac glucomannan sol of step (a) to form a mixture, dissolving the mixture, casting the mixture as a sol, heating the sol to deacetylate the mixture to form a gel and drying the gel to form a film;
(f) when a rigid water soluble film is required, following step (c) but omitting the glycerol or other plasticizer;
(g) when a rigid hot water soluble film is required, following step (d) but omitting the glycerol or other plasticizer;
(h) when a rigid water insoluble film is required, following step (e) but omitting the glycerol or other plasticizer;
(i) when a water-imbibing film that forms an amorphous gel is required, adding an appropriate amount of glycerol and borax to the clarified konjac glucomannan or aloe mannan of step (a), dissolving the mixture, casting the mixture as a film and drying the film;
(j) when a stabilized foam is required, adding a foaming agent and a suitable amount of glycerol to the clarified konjac glucomannan sol of step (a) to form a mixture, aerating the mixture to produce a foam, adding a suitable amount of alkaline agent to the foam, heating the foam to set the foam and drying the foam;
(k) when a flexible rubbery type foam is required, adding a suitable amount of foaming agent, clarified xanthan and glycerol or other plasticizer to the clarified konjac glucomannan or aloe mannan sol of step (a) to form a mixture, heating the mixture to form a sol, aerating the mixture to produce a foam, cooling the foam to set the foam, and drying the foam;
(l) when a sponge cloth-like foam is required, following step (j), but before drying the foam, freezing and thawing the foam, squeezing the foam, rinsing the foam, soaking the foam in isopropyl alcohol and drying the foam;
(m) when a flexible, dry foam which rehydrates to form an amorphous gel is required, adding a suitable amount of detergent and glycerine or other plasticizer to the konjac glucomannan sol of step (a) to form a mixture, aerating the mixture to form a foam, adding a suitable amount of borate to the foam, aerating the foam further, cooling the foam and then drying the foam;
(n) when a firm water absorbent sponge is required, adding an alkaline agent to a sol of the clarified konjac glucomannan of step (a) to form a mixture, heating the mixture until a gel is formed, freezing the gelled mixture, thawing the gelled mixture, and drying the gelled mixture; and
(o) when a flexible water absorbent sponge is required, following step (n) but before drying and after thawing the sponge, soaking the sponge in isopropyl alcohol containing a suitable plasticizer, squeezing the sponge and drying the sponge.

2. A process of producing a clarified guar gum or locust bean gum, gel, film, foam or capsule comprising:
(a) soaking dispersed guar gum or locust bean gum in water until the guar gum or locust bean gum is hydrated, stirring the hydrated guar gum or locust bean gum until a homogenous particulate containing sol is obtained, removing insoluble particulates from the particulate containing sol to produce a clarified sol, and recovering clarified guar gum or locust bean gum from the filtrate; and drying and grinding the filtrate to a powder, and as required, dissolving the powder in water to form a sol;
(b) when a water soluble film is required, adding an appropriate amount of glycerol or other plasticizer to a sol of the clarified guar gum or locust bean gum of step (a), dissolving the guar gum or locust bean gum, glycerol or other plasticizer mixture, casting the mixture as a film, and drying the film;
(c) when a flexible hot water soluble film is required, adding an appropriate amount of xanthan and glycerol or other plasticizer to a sol of clarified guar gum or locust bean gum of step (a) to form a mixture, dissolving the mixture by heating to form a sol, casting the sol, cooling to form a gel and drying the gel to form a film;
(d) when a rigid water soluble film is required, following step (b) but omitting the glycerol or other plasticizer;
(e) when a rigid hot water soluble film is required, following step (c) but omitting the glycerol or other plasticizer;
(f) when a water-imbibing film that forms an amorphous gel is required, adding an appropriate amount of glycerol and borax to a sol of the clarified guar gum or locust bean gum of step (a), casting the sol as a film, allowing the sol to cool to a gel and drying the gel to form a film; and
(g) when a stabilized foam is required, adding a suitable amount of glycerol and xanthan to the clarified guar gum or locust bean gum sol of step (a) to form a mixture, heating the mixture, adding a foaming agent to the mixture, aerating the mixture to produce a foam, cooling the foam to set the foam and drying the foam.

3. A process of producing a clarified konjac glucomannan hydrocolloid gel comprising:
(a) soaking a dispersed konjac glucomannan in water until the konjac glucomannan is hydrated;
(b) stirring the hydrated konjac glucomannan until a homogenous particulate containing sol is obtained;
(c) removing insoluble particulates from the particulate containing sol to produce a clarified sol;
(d) removing remaining particles in the clarified konjac glucomannan sol by filtration;
(e) recovering clarified konjac glucomannan from the filtrate and drying and grinding the filtrate to a powder, and as required, dissolving the powder in water to form a sol; and
(f) adding an appropriate amount of a suitable alkaline agent to a clarified konjac glucomannan sol to deacetylate the sol to form a gel.

4. A process of producing a water soluble flexible hydrocolloid film comprising:
(a) soaking a dispersed hydrocolloid containing material in water until the hydrocolloid is hydrated;
(b) stirring the hydrated hydrocolloid until a homogenous particulate containing sol is obtained;
(c) removing insoluble particulates from the particulate containing sol to produce a clarified sol;
(d) removing remaining particulates in the clarified sol by filtration and recovering clarified hydrocolloid from the filtrate, and drying and grinding the filtrate to a powder, and as required, dissolving the powder in water to form a sol;
(e) adding an appropriate amount of glycerol or other humectant/plasticizer to the clarified hydrocolloid sol to form a mixture;
(f) heating the mixture to boiling; and
(g) depositing the mixture as a layer on a substrate and drying the layer to form a film.

5. A process as claimed in claim 4 wherein the hydrocolloid is selected from one or more of the group consisting of: konjac glucomannan, guar gum, locust bean gum, aloe mannan, agar, agarose, algins, β-, κ-, λ-ι-carrageenans, chitosan, collagen, curdlan and other β-1,3-glucans, fig seed gum (galacturonan), gellan, hyaluronic acid, pectins, Rhizobium gum, Porphyridium cruentum polysaccharide, starch (amylose, amylopectin), acacia gum, gum arabic, chondroitin sulfates, dextrans, flaxseed gum, gum ghatti, inulin (fructan), karaya gum, larch arabinogalactan, levan (fructosan), cassia gum, tara gum, fenugreek gum, oat glucans, okra mucilage, psyllium seed gum, pullulan, quince seed gum, rhamsan, scleroglucan, succinoglucan, tamarind gum, gum tragacanth, wellan, and xanthan gum.

6. A process as claimed in claim 4 wherein the hydrocolloid is konjac glucomannan and a water-insoluble konjac glucomannan film is obtained by adding an appropriate amount of an alkaline agent to the clarified konjac glucomannan hydrocolloid sol and glycerin mixture.

7. A process as claimed in claim 4 wherein the hydrocolloid is konjac glucomannan, aloe mannan or galactomannan and a hot water soluble film is obtained by adding xanthan to the clarified hydrocolloid sol and glycerin mixture.

8. A process as claimed in claim 4 wherein a rigid film is obtained by omitting the glycerine or other plasticizer.

9. A process as claimed in claim 4 wherein a water-imbibing, amorphous gel-forming film is obtained by adding borax to the clarified hydrocolloid and glycerin mixture.

10. A process of producing a clarified hydrocolloid foam comprising:
(a) soaking a dispersed gelling hydrocolloid containing material in water until the hydrocolloid is hydrated;
(b) stirring the hydrated hydrocolloid until a homogenous particulate containing sol is obtained;
(c) removing insoluble particulates from the particulate containing sol to produce a clarified sol;
(d) removing remaining particulates in the clarified sol by filtration;
(e) recovering clarified hydrocolloid from the filtrate, and drying and grinding it to a powder, and as required, dissolving the powder in water to form a sol; and
(f) adding an appropriate amount of a suitable foaming agent to the clarified hydrocolloid sol, whipping the resultant mixture to produce a foam, adding a foam stabilizing reagent, and drying the foam.

11. A process as claimed in claim 10 wherein the hydrocolloid is selected from the group consisting of: konjac glucomannan, guar gum, locust bean gum, aloe mannan, agar, agarose, algins, β-, κ-, ι-carrageenans, chitosan, collagen, curdlan and other β-1,3-glucans, fig seed gum (galacturonan), gellan, hyaluronic acid, pectins, Rhizobium gum, cassia gum, tara gum, fenugreek gum and xanthan gum.

12. A process as claimed in claim 10 wherein glycerin is added to the clarified hydrocolloid before the foaming agent is added.

13. A process as claimed in claim 10 wherein the hydrocolloid is a glucomannan or galactomannan and xanthan and glycerin are added to the clarified hydrocolloid before the foaming agent is added.

14. A process of producing a clarified konjac glucomannan hydrocolloid sponge comprising:
(a) soaking a dispersed konjac glucomannan hydrocolloid containing material in water until the hydrocolloid is hydrated;
(b) stirring the hydrated konjac glucomannan hydrocolloid until a homogenous particulate containing sol is obtained;
(c) removing insoluble particulates from the particulate containing sol to produce a clarified sol;
(d) removing remaining particulates in the clarified sol by filtration;
(e) recovering clarified konjac glucomannan hydrocolloid from the filtrate, and drying and grinding it to a powder, and as required, dissolving the powder in water to form a sol;
(f) adding alkali to the sol, and heating to form a gel;
(g) freezing the konjac glucomannan gel; and
(h) thawing the frozen konjac glucomannan gel to produce a sponge.

15. A process of borating a cis-1,2-diol containing hydrocolloid which comprises:
(a) soaking a dispersed cis-1,2-diol containing hydrocolloid material in water until the hydrocolloid is hydrated;
(b) stirring the hydrated hydrocolloid until a homogenous particulate containing sol is obtained;
(c) removing insoluble particulates from the particulate containing sol to produce a clarified sol;
(d) removing remaining particulates in the clarified sol by filtration;
(e) recovering clarified hydrocolloid from the filtrate, and drying and grinding it to a powder; and
(f) dissolving the clarified hydrocolloid and reacting the clarified hydrocolloid sol with a borate containing agent.

16. A process as claimed in claim 15 wherein the hydrocolloid is konjac glucomannan, aloe mannan, guar gum, locust bean gum, cassia gum, tara gum, or fennugreek gum.

17. A process as claimed in claim 16 wherein a sol of agar, gellan, carrageenan or curdlan is added to the clarified hydrocolloid sol before cross-linking with the borate agent.

18. A gel, film, foam, sponge or capsule produced according to the process of claim 1.

19. A gel, film, foam or capsule produced according to the process of claim 2.

20. A process of preparing a capsule of clarified hydrocolloid which comprises preparing a konjac glucomannan sol or konjac glucomannan or aloe mannan containing film, according to claim 1 and casting the sol as a film on a capsule forming template, drying the film and separating the formed capsule from the template.

21. A process of preparing a capsule of clarified hydrocolloid which comprises preparing a guar gum or locust bean gum containing sol according to claim 2 and casting the sol as a film on a capsule forming template, drying the film and separating the formed capsule from the template.

22. A process of preparing a capsule of clarified hydrocolloid which comprises preparing a konjac glucomannan containing sol according to claim 3 and casting the sol as a film on a capsule forming template, drying the film and separating the formed capsule from the template.

23. A process of preparing a capsule of clarified hydrocolloid which comprises preparing a clarified hydrocolloid film according to claim 4 including casting the film on a capsule forming template, drying the film and separating the formed capsule from the template.

24. A process of preparing a capsule of clarified hydrocolloid which comprises preparing a clarified hydrocolloid film according to claim 5 including casting the film on a capsule forming template, drying the film and separating the formed capsule from the template.

25. A process of preparing a capsule of clarified hydrocolloid which comprises preparing a konjac glucomannan sol according to claim 6 and casting the sol as a film on a capsule forming template, drying the film and separating the formed capsule from the template.

26. A process of preparing a capsule of clarified hydrocolloid which comprises preparing a konjac glucomannan, aloe mannan or galactomannan gel according to claim 7 and casting the sol as a film on a capsule forming template, drying the film and separating the formed capsule from the template.

27. A process of preparing a capsule of clarified hydrocolloid which comprises preparing a clarified hydrocolloid sol according to claim 8 and casting the sol as a film on a capsule forming template, drying the film and separating the formed capsule from the template.

28. A process of forming a low viscosity clarified hydrocolloid sol by causing a particulate hydrocolloid to absorb hydrogen peroxide and then heating the hydrocolloid or permitting the hydrated colloid to remain at room temperature for an extended period.

29. A process of producing a reduced viscosity clarified konjac glucomannan sol which comprises adding hydrogen peroxide to a konjac glucomannan-containing solid, blending the mixture until a homogenous paste is obtained, heating the paste to about 65° C. for about five hours, cooling the mixture to about ambient temperature, adding a filter aid to the mixture, filtering the mixture to obtain a clear filtrate, adding isopropyl alcohol to the clear filtrate to precipitate konjac glucomannan, collecting the coagulated konjac glucomarman, and drying the coagulated konjac glucomannan.

30. A process of producing a hydrocolloid composite containing two or more hydrocolloids which, when hydrated, forms a clear hydrocolloid composite sol which comprises:
(a) soaking a first dispersed hydrocolloid containing material in water until the hydrocolloid is hydrated;
(b) stirring the hydrated hydrocolloid until a homogenous particulate containing sol is obtained;
(c) removing insoluble particulates from the particulate containing sol to produce a clarified sol;
(d) removing remaining particulates in the clarified sol by filtration;
(e) recovering the first clarified hydrocolloid from the filtrate, and drying and grinding it to a powder;
(f) soaking a second dispersed hydrocolloid containing material in water until the hydrocolloid is hydrated;
(g) stirring the hydrated hydrocolloid until a homogenous particulate containing sol is obtained;
(h) removing insoluble particulates from the particulate containing sol to produce a clarified sol;
(i) removing remaining particulates in the clarified sol by filtration;
(j) recovering the second clarified hydrocolloid from the filtrate, and drying and grinding it to a powder;
(k) dispersing the first clarified hydrocolloid and the second clarified hydrocolloid in water;
(l) mixing the dispersed first clarified hydrocolloid and the dispersed second clarified hydrocolloid to obtain a homogenous mixture;
(m) coagulating the first hydrocolloid with the second hydrocolloid as a precipitate by adding a miscible alcohol;
(n) collecting the coagulated hydrocolloid composite; and
(o) drying the composite and grinding it to form a powder.

31. A process as claimed in claim 30 wherein a sodium chloride solution is included in step (k) to enhance coagulation.

32. A process as claimed in claim 30 wherein the miscible alcohol is isopropyl alcohol.

33. A process as claimed in claim 30 wherein the dispersed in water first and second clarified hydrocolloids are boiled to assist sol formation.

34. A process as claimed in claim 30 wherein a water soluble alkyl cellulose is substituted for the second hydrocolloid, or added in addition to it.

35. A process as claimed in claim 30 wherein the first clarified hydrocolloid is konjac glucomannan.

36. A process as claimed in claim 35 wherein the second clarified hydrocolloid is clarified guar sol, locust bean gum sol, agar sol or xanthan sol.

37. A process as claimed in claim 30 wherein the first hydrocolloid is clarified guar sol and the second hydrocolloid is clarified xanthan sol.

38. A clarified hydrocolloid composite selected from the group consisting of clarified konjac and clarified guar gum which composition forms a clear sol when mixed with water, clarified konjac and clarified xanthan gum which composition forms a clear sol when mixed with water, clarified xanthan gum and clarified guar gum which composition forms a clear sol when mixed with water, a clarified aloe mannan and clarified guar gum which composition forms a clear sol when mixed with water, clarified konjac and clarified agar which composition forms a clear sol when mixed with water, clarified aloe mannan and clarified konjac which composition forms a clear sol when mixed with water, clarified konjac and clarified locust bean gum which composition forms a clear sol when mixed with water, clarified konjac and clarified carboxymethyl cellulose which composition forms a clear sol when mixed with water, and clarified guar gum and clarified carboxymethyl cellulose which composition forms a clear sol when mixed with water, produced according to the process of claim 30.

39. A process of preparing a capsule of clarified hydrocolloid which comprises preparing a clarified hydrocolloid film according to claim 30 including casting the film on a capsule forming template, drying the film and separating the formed capsule from the template.

40. A process of preparing a clarified hydrocolloid composite capsule which comprises preparing a clarified guar, agar gel composite; or a guar, xanthan gel composite, or agar, konjac glucomannan gel composite; or konjac glucomannan, xanthan gel composite, or a hydrogen peroxide induced low-viscosity konjac glucomannan, xanthan gel composite; or a guar, xanthan gel composite on a capsule forming template, drying the composite to form a capsule film, and separating the capsule from the template.

41. A process of producing a clarified konjac glucomannan gel or sponge, or clarified konjac glucomannan or clarified aloe mannan film, foam or capsule comprising:
(a) soaking dispersed konjac glucomannan or aloe mannan in water until the konjac glucomannan or aloe mannan is hydrated; stirring the hydrated konjac glucomannan or aloe mannan until a homogenous particulate containing sol is obtained; removing insoluble particulates from the particulate containing sol to produce a clarified sol; recovering clarified konjac glucomannan or aloe mannan from the filtrate;
(b) when a konjac glucomannan gel is required, adding an appropriate amount of a suitable alkaline agent to a sol of the clarified konjac glucomannan of step (a) to deacetylate the sol to form a gel;
(c) when a flexible water soluble film is required, adding an appropriate amount of glycerol or other plasticizer to a sol of the clarified konjac glucomannan or aloe mannan of step (a), dissolving the konjac glucomannan or aloe mannan, glycerol or other plasticizer mixture, casting the mixture as a film, and drying the film;
(d) when a flexible hot water soluble film is required, adding an appropriate amount of xanthan and glycerol or other plasticizer to the clarified konjac glucomannan or aloe mannan sol of step (a) to form a mixture, dissolving the mixture, casting the mixture as a film, cooling the film to a gel and drying the gel to form a film;
(e) when a flexible water-insoluble film is required, adding an appropriate amount of glycerol or other plasticizer and alkaline agent to the clarified konjac glucomannan sol of step (a) to form a mixture, dissolving the mixture, casting the mixture as a sol, heating the sol to deacetylate the mixture to form a gel and drying the gel to form a film;
(f) when a rigid water soluble film is required, following step (c) but omitting the glycerol or other plasticizer;
(g) when a rigid hot water soluble film is required, following step (d) but omitting the glycerol or other plasticizer;
(h) when a rigid water insoluble film is required, following step (e) but omitting the glycerol or other plasticizer;
(i) when a water-imbibing film that forms an amorphous gel is required, adding an appropriate amount of glycerol and borax to the clarified konjac glucomannan or aloe mannan of step (a), dissolving the mixture, casting the mixture as a film and drying the film;
(j) when a stabilized foam is required, adding a foaming agent and a suitable amount of glycerol to the clarified konjac glucomannan sol of step (a) to form a mixture, aerating the mixture to produce a foam, adding a suitable amount of alkaline agent to the foam, heating the foam to set the foam and drying the foam;
(k) when a flexible rubbery type foam is required, adding a suitable amount of foaming agent, clarified xanthan and glycerol or other plasticizer to the clarified konjac glucomannan or aloe mannan sol of step (a) to form a mixture, heating the mixture to form a sol, aerating the mixture to produce a foam, cooling the foam to set the foam, and drying the foam;
(l) when a sponge cloth-like foam is required, following step (j), but before drying the foam, freezing and thawing the foam, squeezing the foam, rinsing the foam, soaking the foam in isopropyl alcohol and drying the foam;
(m) when a flexible, dry foam which rehydrates to form an amorphous gel is required, adding a suitable amount of detergent and glycerine or other plasticizer to the konjac glucomannan sol of step (a) to form a mixture, aerating the mixture to form a foam, adding a suitable amount of borate to the foam, aerating the foam further, cooling the foam and then drying the foam;
(n) when a firm water absorbent sponge is required, adding an alkaline agent to a sol of the clarified konjac glucomannan of step (a) to form a mixture, heating the mixture until a gel is formed, freezing the gelled mixture, thawing the gelled mixture, and drying the gelled mixture; and
(o) when a flexible water absorbent sponge is required, following step (n) but before drying and after thawing the sponge, soaking the sponge in isopropyl alcohol containing a suitable plasticizer, squeezing the sponge and drying the sponge.

42. A process of producing a clarified guar gum or locust bean gum, gel, film, foam or capsule comprising:
(a) soaking dispersed guar gum or locust bean gum in water until the guar gum or locust bean gum is hydrated, stirring the hydrated guar gum or locust bean gum until a homogenous particulate containing sofis obtained, removing insoluble particulates from the particulate containing sol to produce a clarified sol, and recovering clarified guar gum or locust bean gum from the filtrate;
(b) when a water soluble film is required, adding an appropriate amount of glycerol or other plasticizer to a sol of the clarified guar gum or locust bean gum of step (a), dissolving the guar gum or locust bean gum, glycerol or other plasticizer mixture, casting the mixture as a film, and drying the film;
(c) when a flexible hot water soluble film is required, adding an appropriate amount of xanthan and glycerol or other plasticizer to a sol of clarified guar gum or locust bean gum of step (a) to form a mixture, dissolving the mixture by heating to form a sol, casting the sol, cooling to form a gel and drying the gel to form a film;
(d) when a rigid water soluble film is required, following step (b) but omitting the glycerol or other plasticizer;
(e) when a rigid hot water soluble film is required, following step (c) but omitting the glycerol or other plasticizer;
(f) when a water-imbibing film that forms an amorphous gel is required, adding an appropriate amount of glycerol and borax to a sol of the clarified guar gum or locust bean gum of step (a), casting the sol as a film, allowing the sol to cool to a gel and drying the gel to form a film; and
(g) when a stabilized foam is required, adding a suitable amount of glycerol and xanthan to the clarified guar gum or locust bean gum sol of step (a) to form a mixture, heating the mixture, adding a foaming agent to the mixture, aerating the mixture to produce a foam, cooling the foam to set the foam and drying the foam.

43. A process of producing a clarified konjac glucomannan hydrocolloid gel comprising:
(a) soaking a dispersed konjac glucomannan in water until the konjac glucomannan is hydrated;
(b) stirring the hydrated konjac glucomannan until a homogenous particulate containing sol is obtained;
(c) removing insoluble particulates from the particulate containing sol to produce a clarified sol;
(d) removing remaining particles in the clarified konjac glucomannan sol by filtration;
(e) recovering clarified konjac glucomannan from the filtrate; and
(f) adding an appropriate amount of a suitable alkaline agent to a clarified konjac glucomannan sol to deacetylate the sol to form a gel.

44. A process of producing a water soluble flexible hydrocolloid film comprising:
(a) soaking a dispersed hydrocolloid containing material in water until the hydrocolloid is hydrated;
(b) stirring the hydrated hydrocolloid until a homogenous particulate containing sol is obtained;
(c) removing insoluble particulates from the particulate containing sol to produce a clarified sol;
(d) removing remaining particulates in the clarified sol by filtration and recovering clarified hydrocolloid from the filtrate;
(e) adding an appropriate amount of glycerol or other plasticizer to the clarified hydrocolloid sol to form a mixture;
(f) heating the mixture to boiling; and
(g) depositing the mixture as a layer on a substrate and drying the layer to form a film.

45. A process of producing a clarified hydrocolloid foam comprising:
(a) soaking a dispersed gelling hydrocolloid containing material in water until the hydrocolloid is hydrated;
(b) stirring the hydrated hydrocolloid until a homogenous particulate containing sol is obtained;
(c) removing insoluble particulates from the particulate containing sol to produce a clarified sol;
(d) removing remaining particulates in the clarified sol by filtration;
(e) recovering clarified hydrocolloid from the filtrate; and
(f) adding an appropriate amount of a suitable foaming agent to the clarified hydrocolloid sol, whipping the resultant mixture to produce a foam, adding a foam stabilizing reagent, and drying the foam.

46. A process of producing a clarified konjac glucomannan hydrocolloid sponge comprising:
(a) soaking a dispersed konjac glucomannan hydrocolloid containing material in water until the hydrocolloid is hydrated;
(b) stirring the hydrated konjac glucomannan hydrocolloid until a homogenous particulate containing sol is obtained;
(c) removing insoluble particulates from the particulate containing sol to produce a clarified sol;
(d) removing remaining particulates in the clarified sol by filtration;
(e) recovering clarified konjac glucomannan hydrocolloid from the filtrate;
(f) adding alkali to the sol, and heating to form a gel;
(g) freezing the konjac glucomannan gel; and
(h) thawing the frozen konjac glucomannan gel to produce a sponge.
